(19) United States
(12) Patent Application Publication
(10) Pub. No.: US 2026/0214142 A1
(43) Pub. Date: Jul. 23, 2026

(54) INTEGRATION PLATFORM FOR BIDIRECTIONAL COMMUNICATION WITH HETEROGENOUS NETWORKED SYSTEMS VIA AN INTEGRATED FRONTEND INTERFACE

(71) Applicant: Haven Servicing, Inc., Madison, NJ (US)

(72) Inventors: Jonathan CHAO, Austin, TX (US); Brian MILNER, Cumming, GA (US); Walter ZIELENSKI, Kingston, NY (US); Christopher HILL, Austin, TX (US); William CLARK, Austin, TX (US); Stacy NG, Oakland, CA (US)

(21) Appl. No.: 19/369,046

(22) Filed: Oct. 24, 2025

Related U.S. Application Data
(60) Provisional application No. 63/711,532, filed on Oct. 24, 2024.

(51) Int. Cl. H04L 67/12

(52) U.S. Cl. CPC H04L 67/12

(57) ABSTRACT

A method, apparatus, and computer-readable medium of an integration platform for bidirectional communication with heterogenous networked systems via an integrated frontend interface, the method including transmitting a frontend interface for display to a user, embedding a second interface within the frontend interface, detecting an event in the second interface of the frontend interface, determining that the event corresponds to the second entity computer system based at least in part on detecting the event in the second interface of the frontend interface, transforming the event into a second entity event that is interpretable by the second entity computer system, and transmitting the second entity event to the second entity computer system over the computer network.

### RELATED APPLICATION DATA

This application claims priority to U.S. Provisional Application No. 63/711,532, filed Oct. 24, 2024, the disclosure of which is hereby incorporated by reference in its entirety.

### FIELD

The present invention relates to a method, an apparatus, and a computer-readable medium of an integration platform for bidirectional communication with heterogenous networked systems via an integrated frontend interface.

### BRIEF DESCRIPTION OF THE DRAWINGS

FIG. 1A illustrates a system diagram of an integration platform for bidirectional communication with heterogenous networked systems via an integrated frontend interface according to an exemplary embodiment.

FIG. 1B illustrates another system diagram of an integration platform for bidirectional communication with heterogenous networked systems via an integrated frontend interface according to an exemplary embodiment.

FIG. 2 illustrates a flowchart for bidirectional communication with heterogenous networked systems via an integrated frontend interface according to an exemplary embodiment.

FIG. 3 illustrates a system diagram of the integration platform, showing the performance of the steps of the flowchart of FIG. 2 according to an exemplary embodiment.

FIG. 4 illustrates a flowchart for updating the integration platform in response to an external event from an external computer system according to an exemplary embodiment. Each of the steps shown in the figure can be executed by the integration platform.

FIG. 5 illustrates a flowchart for transforming the event into a second entity event that is interpretable by the second entity computer system according to an exemplary embodiment.

FIG. 6 illustrates a system diagram of the integration platform, showing the performance of the steps of the flowchart of FIG. 5 according to an exemplary embodiment.

FIG. 7 illustrates a system chart for updating the state of the integration platform in response to an external event according to an exemplary embodiment.

FIGS. 8A-8C illustrate system charts showing the updating of the integration platform to replace one external entity with another external entity according to an exemplary embodiment.

FIG. 9 illustrates a flowchart storing and partitioning data in database of the integration platform according to an exemplary embodiment.

FIG. 10 illustrates a system chart showing the partitioning and access control of the database according to an exemplary embodiment.

FIG. 11 illustrates a flowchart for detecting and processing events in the first interface of the frontend interface of the integration platform according to an exemplary embodiment.

FIG. 12 illustrates a flowchart for consistency validation and alerting according to an exemplary embodiment.

FIG. 13 illustrates another flowchart for consistency validation and alerting according to an exemplary embodiment.

FIG. 14 illustrates a system chart showing the data consistency and alerting functionality of the database according to an exemplary embodiment.

FIG. 15 illustrates the specialized computing environment 1500 of the integration platform that is used to perform the above-described methods and implement the above- described systems.

FIGS. 16A-16H illustrate example screenshots and diagrams of the present platform according to an exemplary embodiment.

### DETAILED DESCRIPTION

While methods, systems, and computer-readable media are described herein by way of examples and embodiments, those skilled in the art recognize that methods, apparatuses, and computer-readable media for bidirectional communication with heterogenous networked systems via an integrated frontend interface are not limited to the embodiments or drawings described. The drawings and description are not intended to be limited to the particular form disclosed. Rather, the intention is to cover all modifications, equivalents and alternatives falling within the spirit and scope of the present disclosure and claims. Any headings used herein are for organizational purposes only and are not meant to limit the scope of the description or the claims. As used herein, the word "can" is used in a permissive sense (i.e., meaning having the potential to) rather than the mandatory sense (i.e., meaning must). Similarly, the words "include," "including," and "includes" mean including, but not limited to.

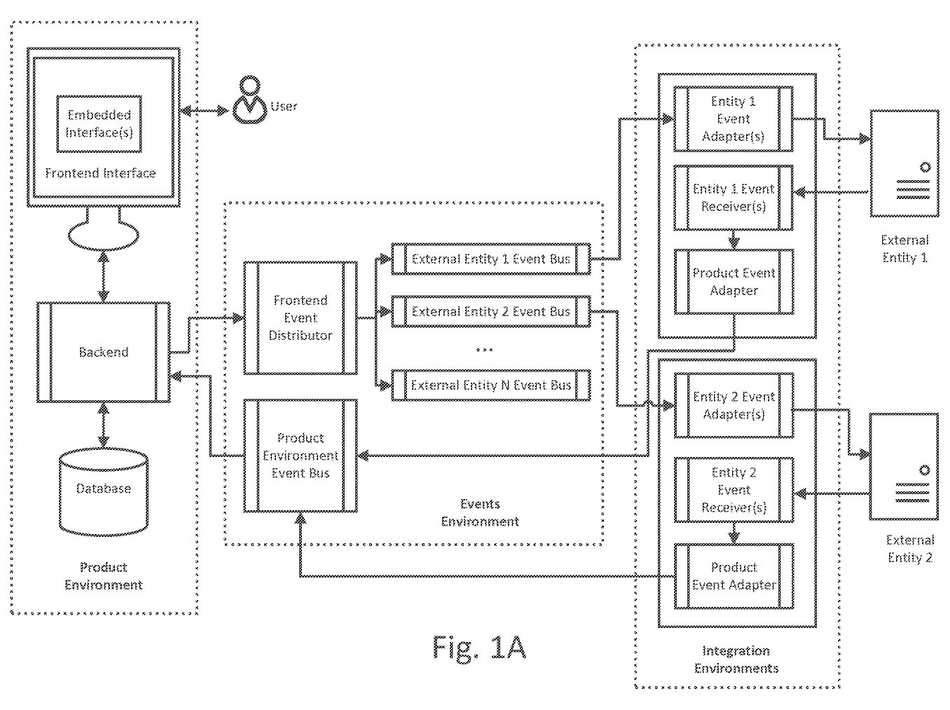

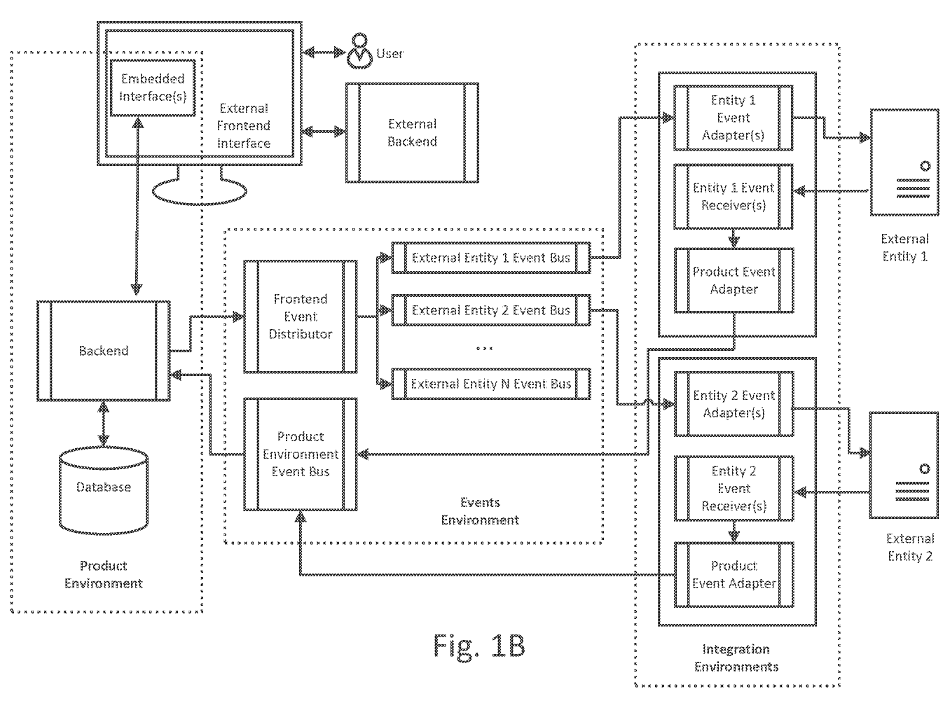

FIG. 1A illustrates a system diagram of an integration platform (the "platform") for bidirectional communication with heterogenous networked systems via an integrated frontend interface according to an exemplary embodiment. As will be described in greater detail below, the integration platform, can be, for example, a loan servicing and management platform used by borrowers, lenders, and servicers, referred to herein as the Haven Platform.

As shown in FIG. 1A, the integration platform includes a product environment, an events environment, and an integration environment. The product environment directly manages the user-facing aspects of the platform. In the scenario where the present system is implemented as the Haven Platform, the user can be a borrower. The events environment can manage event buses, which are message queues that receive messages from one side of the platform and hold them until they are read and processed by another side of the platform. The order of the messages can be, for example, first-in-first-out (FIFO). Additionally, the integrations environments are a set of one or more environments, each of which maps to and from a specific external entity, also referred to as a partner. In the Haven Platform, the external entities can include lenders, originators, and/or servicers. Each integration environment manages the integration of data, processes, and logic between the product environment and the external entity. As will be discussed in greater detail below, the integration environments can include one or more adapters that convert data structures provided by the external entities into data structures that can be interpreted and utilized by the product environment, and vice versa.

The product environment can include a frontend interface. The frontend interface can be, for example, a mobile application, a desktop application, and/or a website. The frontend interface can include a first interface corresponding to a first entity computer system on a computer network, and the integration platform can be configured to expose one or more first functionalities mapped to the first entity computer system to the user via the first interface. Optionally, the first interface can be an embedded interface within the frontend interface.

The frontend interface can additionally include embedded interfaces, including a second interface within the frontend interface. The second interface can correspond to a second entity computer system on the computer network, and the integration platform can be configured to expose one or more second functionalities mapped to the second entity computer system to the user via the second interface. The second interface can be distinct, separate, or partitioned from the first interface, and the first entity computer system and the second entity computer system correspond to distinct entities on the computer network. In the example shown in FIG. 1A, the frontend interface is part of product environment of the integration platform. In the example shown in FIG. 1B, the frontend interface can be an external frontend interface of site outside of the integration platform, but which still includes embedded interfaces that form part of the integration platform.

The product environment additionally includes a backend system. The backend system supports the features of the frontend interface (e.g., Web or Mobile Applications) through, for example, RESTAPIs or GraphQL APIs. The backend system also contains the computer-program code configured to send various events from the product environment into the events environment and also to read the events from the events environment to effect changes in the product environment database. The functionality of backend system is explained in greater detail below.

Events are actions occurring on the platform, either resulting from user action on the frontend or the actions of external entities that interface with the platform. Events can include events occurring in the product environment that are of significance or have any impact on one or more of the external entities or events occurring on an external entity system that impact the product environment. In the Haven Platform, events can be an event in the product environment that is of significance to a Servicer or Originator/Lender of a loan, such as an update to payment preferences, expression of an interest in refinancing, or other events. Additionally, in the Haven Platform, events can include an event related to the loan which occurs on the side of the Servicer or Lender/Originator which then needs to be reflected on frontend and product environment, such as processing of a payment, update in account balances (escrow, principal, etc.), failure of payment, etc.

The product environment additionally includes a database which stores all relevant information pertaining to a user and/or external entities. The database is described in greater detail below and can include information about the user, as well as user data corresponding to different external entities. For example, in the Haven Platform, the database can store information about a borrower, borrower history, borrower records with specific lender (i.e., external entity), borrower records with a specific servicer (i.e., another external entity), and other data relevant to the borrower.

The event environment includes a frontend event distributer, which implements detection and routing logic to identify any external entities related to frontend events and forwards the events to event buses specific to the identified external entities. The event environment also includes one or more event buses, such as the External Entity 1 Event Bus and the External Entity 2 Event Bus. Each of these Event Buses stores a queue of event messages for delivery to the relevant External Entity. Although not shown in FIG. 1A, the event messages in the event bus can include event data properties and event type properties. The event type properties encapsulates what type of an event the platform wants to update an external entity regarding. For example, in the Haven Platform, "payment-preferences-updated" and "customer-service-ticket-submitted" are two possible events. The event data can be, for example, JSON object that contains data pertaining to the associated event type. For example, in the Haven Platform, the data for the "payment-preferences-updated" event type can have "payment-routing-number" and "payment-account-number" as datapoints. Each partner of the integration platform can have an associated external entity event bus to queue event messages corresponding to that partner.

As shown in FIG. 1A, the event environment additionally includes a product environment event bus. The product environment event bus is a queue of event messages that can also contain the same properties as the above-mentioned event messages. The messages in this queue are sent based on events occurring on the external entities (i.e., partner) sides that are passed to the product environment and that result in updates to the product environment of the integration platform.

The integration environments include entity-specific integration environments corresponding to each external entity that is a partner of the integration platform. Each entity- specific integration environment includes event adapters, event receivers, and product event adapters. Event adapters transform events on the integration platform into corresponding events that are compatible with and interpretable by the corresponding external entity system. Event receivers receive external events from external entities and forward them to product event adapters. Event receivers can optionally save copies of external events. Product event adapters receive events sent by partners/external entities in a structure that is specific to the external entity, transform the event data into a structure that can be consumed by the product environment, and send the transformed data into the product environment event bus in the events environment.

Additionally, although not shown in FIGS. 1A-1B, each entity-specific integration environment can include event type distributors and event type adapters. The event type distributors are executable code that form part of the integration environment specific to an external entity and read events from the event bus for that external entity, check the event type of each specific event, and forward the events to the corresponding event type adapter. For example, in the Haven platform, an event of type "payment-preferences-updated" can be sent to a "payment-preferences" adapter. The event type adapters are executable code that receive events from product environment, transform the data in the event into a structure that will be accepted by partner systems, and send this transformed data to the partner (e.g., a servicer, originator, or lender in the Haven Platform).

FIG. 1B illustrates another system diagram of an integration platform for bidirectional communication with heterogenous networked systems via an integrated frontend interface according to an exemplary embodiment. The system diagram shown in FIG. 1B is similar to the system diagram shown in Fig. lA, except in this example, the frontend interface is an external frontend interface that does not form part of the product environment. However, the external frontend interface includes one or more embedded interfaces that do form part of the product environment and which are connected to the backend. The external frontend interface can have its own external backend, separate from the backend of the integration platform. In this example, the first interface can be part of the external frontend interface and the second interface can be one of the embedded interfaces. Alternatively, both the first and second interfaces can be part of the embedded interfaces. The example shown in FIG. 1B allows the integration platform to be embedded within existing external frontends and still provide the benefits and functionality provided by native frontends of the integration platform. For example, the Haven Platform can include an embedded servicing module or plugin that integrates with a website of a lender, the embedded servicing module can embed a servicing interface within the native interface of a lender website or mobile app. This serving interface can be linked, through the integration platform, to a servicer system that is wholly distinct and separate from the lender system. Additional details regarding this specific implementation are described further below.

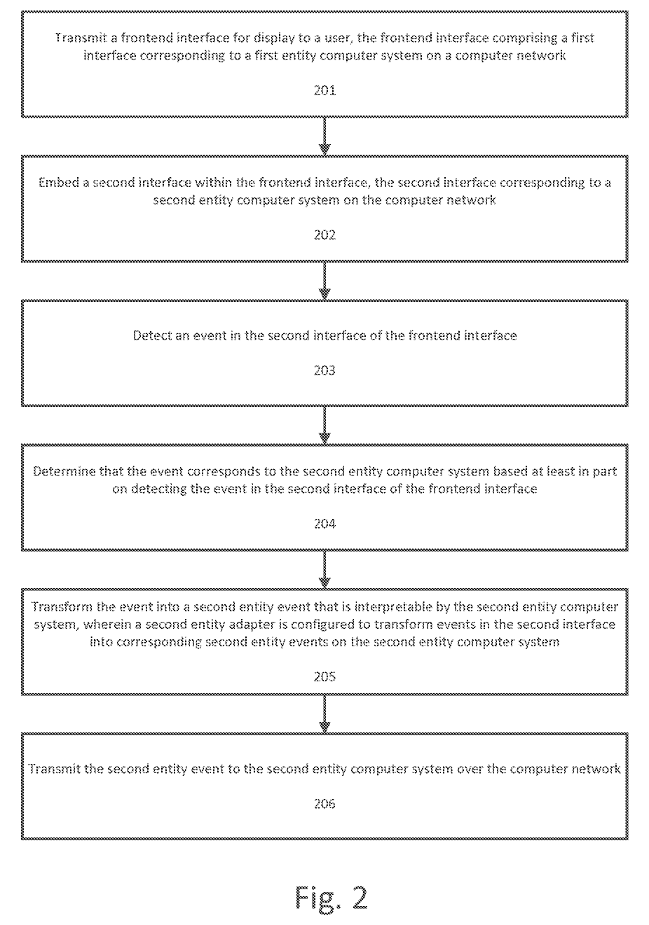

FIG. 2 illustrates a flowchart for bidirectional communication with heterogenous networked systems via an integrated frontend interface according to an exemplary embodiment. Each of the steps shown in the figure can be executed by the integration platform.

At step 201 a frontend interface is transmitted for display to a user, the frontend interface comprising a first interface corresponding to a first entity computer system on a computer network, wherein the integration platform is configured to expose one or more first functionalities mapped to the first entity computer system to the user via the first interface.

At step 202 a second interface is embedded within the frontend interface, the second interface corresponding to a second entity computer system on the computer network, wherein the integration platform is configured to expose one or more second functionalities mapped to the second entity computer system to the user via the second interface, wherein the second interface is distinct from the first interface, and wherein the first entity computer system and the second entity computer system comprise distinct entities on the computer network.

At step 203 an event is detected in the second interface of the frontend interface.

At step 204 the integration platform determines that the event corresponds to the second entity computer system based at least in part on detecting the event in the second interface of the frontend interface.

At step 205 the event is transformed into a second entity event that is interpretable by the second entity computer system, wherein a second entity adapter is configured to transform events in the second interface into corresponding second entity events on the second entity computer system.

At step 206 the second entity event is transmitted to the second entity computer system over the computer network.

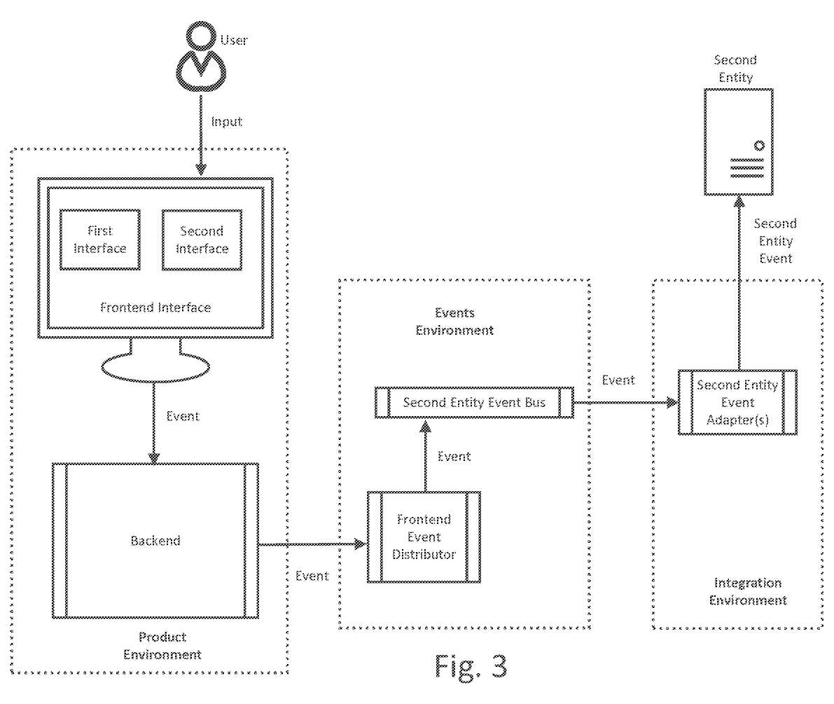

FIG. 3 illustrates a system diagram of the integration platform, showing the performance of the steps of the flowchart of FIG. 2 according to an exemplary embodiment. The components of the integration platform shown in FIG. 3 include only those components relevant to the steps of the flowchart of FIG. 2. It is understood that the integration platform can include additional components not shown in FIG. 3, such as any of the components shown in FIGS. 1A-1B.

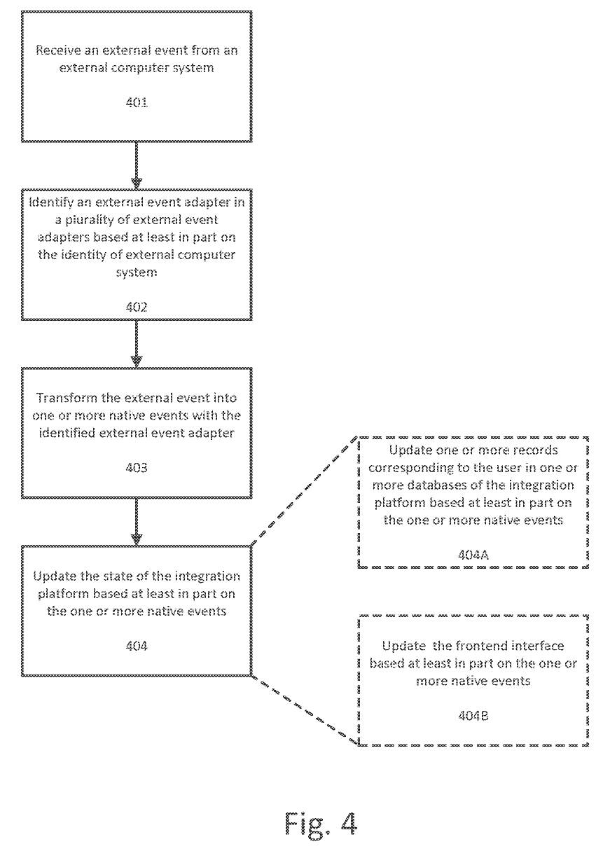

FIG. 4 illustrates a flowchart for updating the integration platform in response to an external event from an external computer system according to an exemplary embodiment. Each of the steps shown in the figure can be executed by the integration platform.

At step 401 an external event is received from an external computer system. The external computer system can be the first entity computer system or the second entity computer system. The external computer system can be the second entity computer system and the external event can be received from the second entity computer system in response to a second entity event transmitted to the second entity computer system.

At step 402 an external event adapter is identified in a plurality of external event adapters based at least in part on the identity of external computer system.

At step 403 the external event is transformed into one or more native events with the identified external event adapter, the one or more native events being configured to update a state of the integration platform.

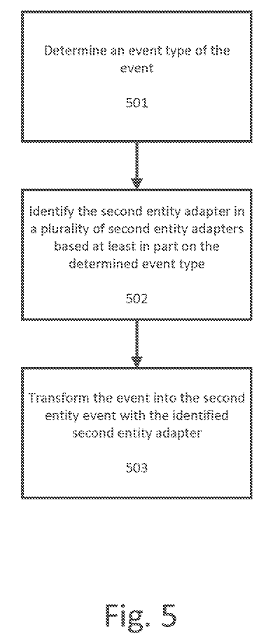

FIG. 5 illustrates a flowchart for transforming the event into a second entity event that is interpretable by the second entity computer system according to an exemplary embodiment.

At step 501 an event type of the event is determined.

At step 502 the second entity adapter is identified in a plurality of second entity adapters based at least in part on the determined event type, the identified second entity adapter being configured to transform events of the event type into corresponding second entity events of the same event type.

At step 503 the event is transformed into the second entity event with the identified second entity adapter.

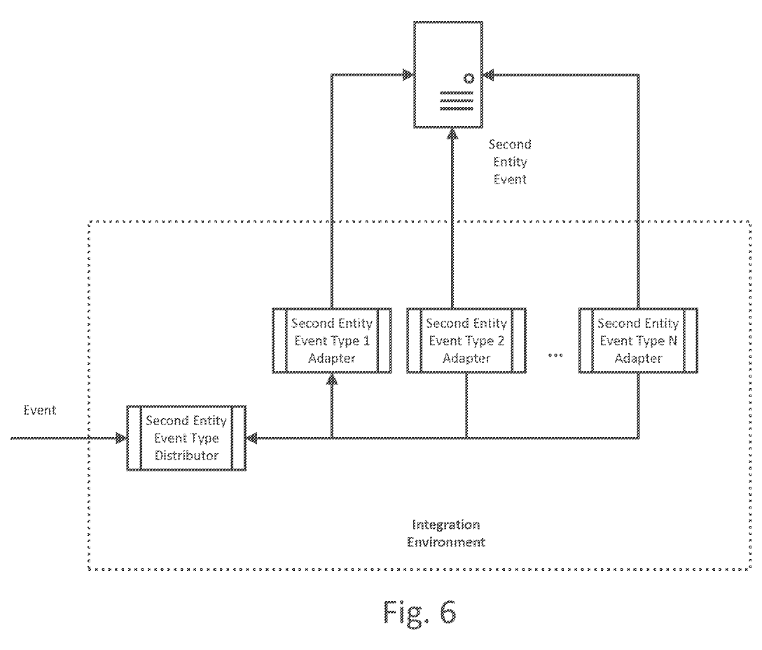

FIG. 6 illustrates a system diagram of the integration platform, showing the performance of the steps of the flowchart of FIG. 5 according to an exemplary embodiment. The components of the integration platform shown in FIG. 6 include only those components relevant to the steps of the flowchart of FIG. 5. It is understood that the integration platform can include additional components not shown in FIG. 6, such as any of the components shown in FIGS. 1A-1B.

Returning to FIG. 4, at step 404 the state of the integration platform is updated based at least in part on the one or more native events.

Updating the state of the integration platform based at least in part on the one or more native events can include updating one or more records corresponding to the user in one or more databases of the integration platform based at least in part on the one or more native events.

Updating the state of the integration platform based at least in part on the one or more native events can include updating the frontend interface based at least in part on the one or more native events. The external computer system can be the second entity computer system and updating the frontend interface based at least in part on the one or more native events can include updating the second interface of the frontend interface based at least in part on the one or more native events.

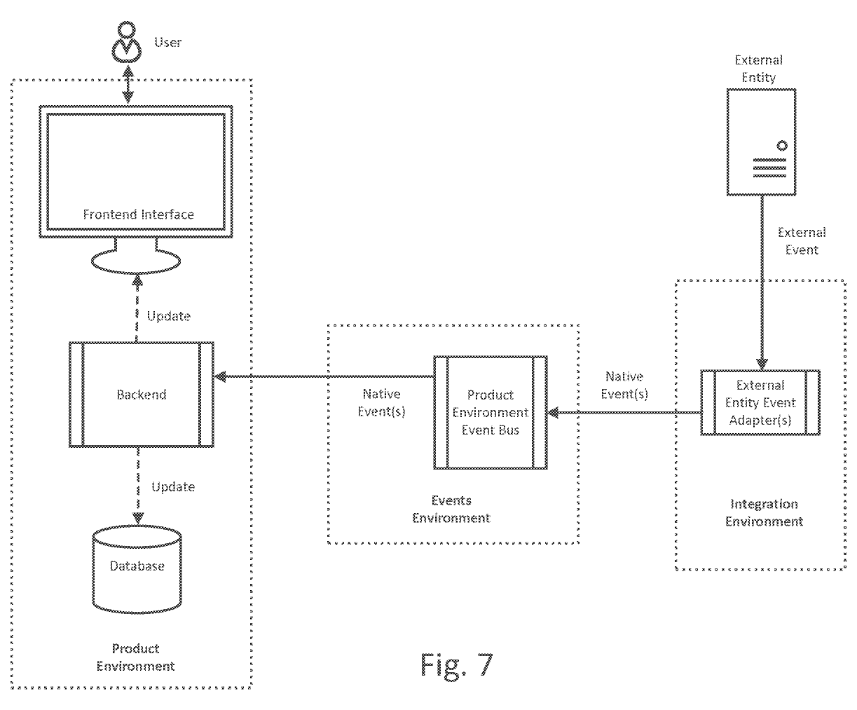

FIG. 7 illustrates a system chart for updating the state of the integration platform in response to an external event according to an exemplary embodiment. The components of the integration platform shown in FIG. 7 include only those components relevant to steps of updating the state of the integration platform. It is understood that the integration platform can include additional components not shown in FIG. 7, such as any of the components shown in FIGS. 1A-1B.

The external event can include a replacement event configured to replace the second entity computer system with a third entity computer system on the computer network and updating the state of the integration platform based at least in part on the one or more native events can include reconfiguring the embedded second interface to correspond to the third entity computer system, such that the exposed one or more second functionalities within the second interface are mapped to the third entity computer system rather than the second entity computer system. Updating the state of the integration platform based at least in part on the one or more native events can include retrieving user data corresponding to the user from the third entity computer system via a third entity external event adapter in the plurality of external event adapters and storing user data in one or more databases of the integration platform. In the example of the Haven Platform, a replacement event can include a transfer from one loan servicer to another loan servicer. When a replacement event occurs, the integration platform can additionally perform the steps of retrieving user settings data from one or more databases of the integration platform, the user settings data corresponding to the user and second entity computer system, and transmitting one or more instructions to the third entity computer system based at least in part on the user settings data.

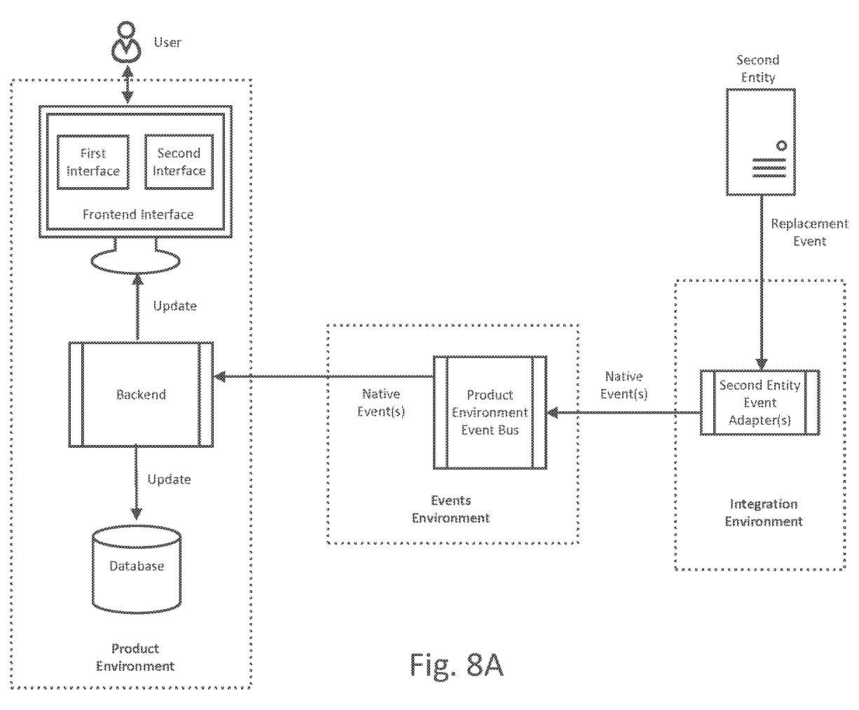

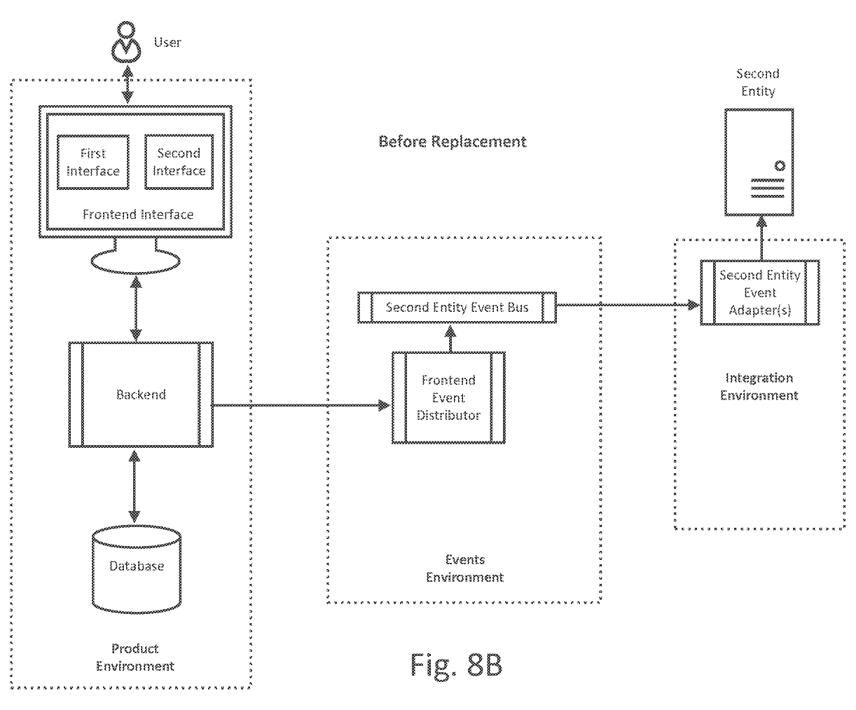

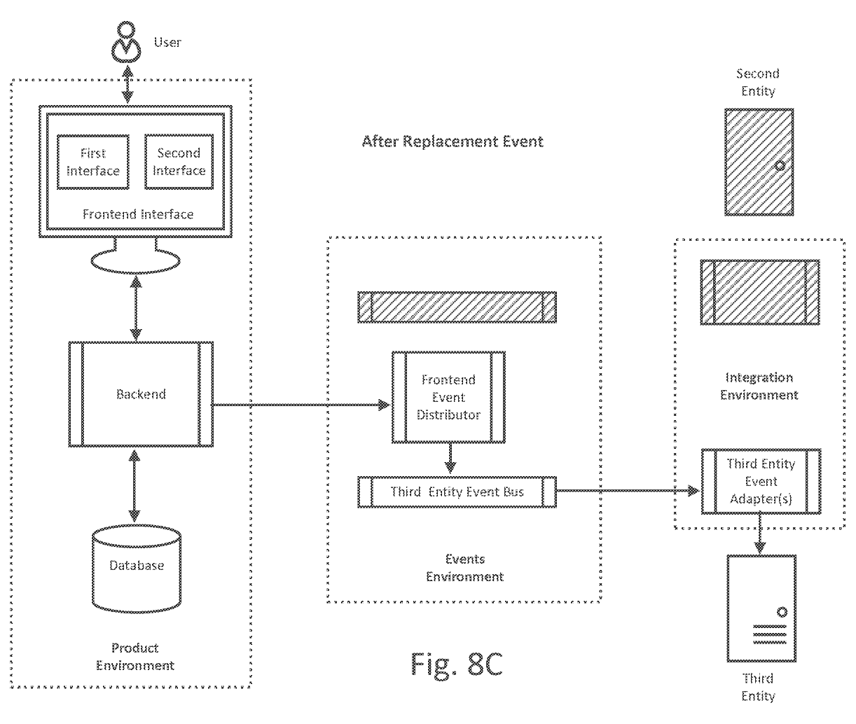

FIGS. 8A-8C illustrate system charts showing the updating of the integration platform to replace one external entity with another external entity according to an exemplary embodiment. The components of the integration platform shown in FIGS. 8A-8C include only those components relevant to steps of replacing one external entity with another external entity. It is understood that the integration platform can include additional components not shown in FIGS. 8A-8C, such as any of the components shown in FIGS. 1A-1B. Note that the FIGS. 8A-8C illustrate the changes relative to a particular user, and it is understood that although the second entity may be removed for that user, it may continue to be connected to the integration platform for other users.

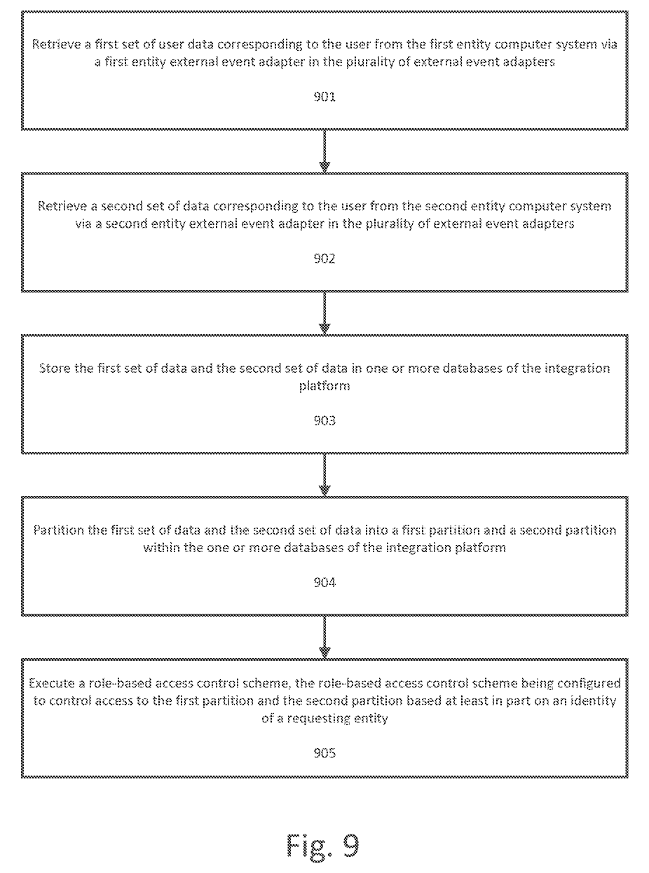

FIG. 9 illustrates a flowchart storing and partitioning data in database of the integration platform according to an exemplary embodiment.

At step 901 a first set of user data corresponding to the user is retrieved from the first entity computer system via a first entity external event adapter in the plurality of external event adapters.

At step 902 a second set of data corresponding to the user is retrieved from the second entity computer system via a second entity external event adapter in the plurality of external event adapters.

At step 903 the first set of data and the second set of data are stored in one or more databases of the integration platform.

At step 904 the first set of data and the second set of data are partitioned into a first partition and a second partition within the one or more databases of the integration platform.

At step 905 a role-based access control scheme is executed, the role-based access control scheme being configured to control access to the first partition and the second partition based at least in part on an identity of a requesting entity. The role-based access control scheme can be configured such that at least a portion of the first partition is accessible to the first entity computer system but the second partition is not accessible to first entity computer system, at least a portion of the second partition is accessible to the second entity computer system but the first partition is not accessible to first entity computer system, and at least a portion of the first partition and the second partition are accessible to the user.

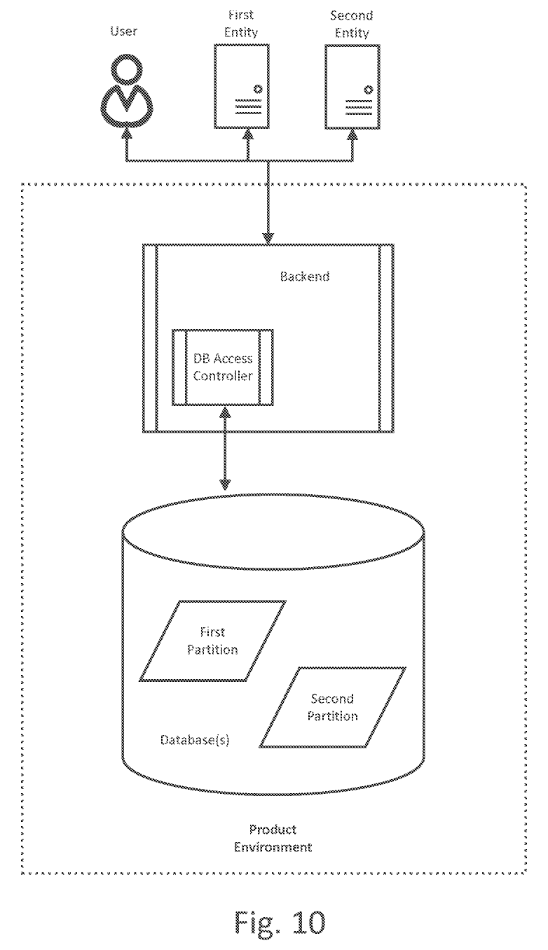

FIG. 10 illustrates a system chart showing the partitioning and access control of the database according to an exemplary embodiment. The components of the integration platform shown in FIG. 10 include only those components relevant to steps of partitioning and access control of the database. It is understood that the integration platform can include additional components not shown in FIG. 10, such as any of the components shown in FIGS. 1A- 1B.

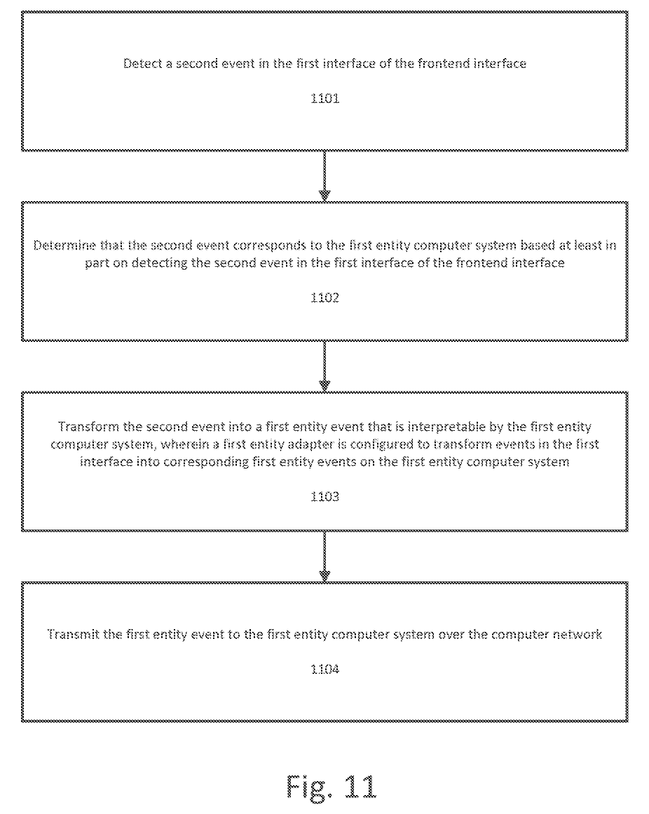

FIG. 11 illustrates a flowchart for detecting and processing events in the first interface of the frontend interface of the integration platform according to an exemplary embodiment. The steps shown in FIG. 11 are performed by the integration platform.

At step 1101 a second event in the first interface of the frontend interface is detected.

At step 1102 the integration platform determines that the second event corresponds to the first entity computer system based at least in part on detecting the second event in the first interface of the frontend interface.

At step 1103 the second event is transformed into a first entity event that is interpretable by the first entity computer system, the first entity adapter being configured to transform events in the first interface into corresponding first entity events on the first entity computer.

At step 1103 the first entity event is transmitted to the first entity computer system over the computer network.

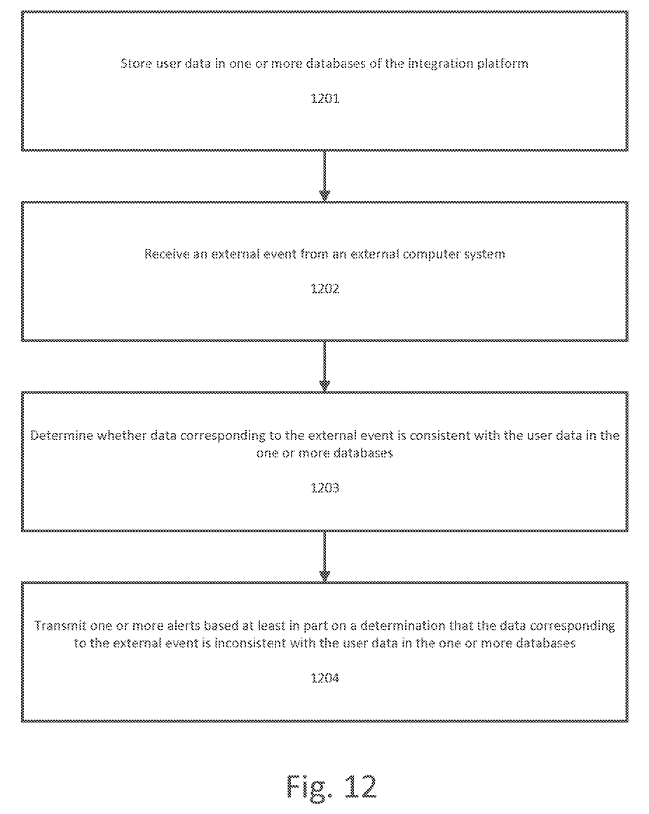

FIG. 12 illustrates a flowchart for consistency validation and alerting according to an exemplary embodiment. The steps shown in FIG. 12 are performed by the integration platform.

At step 1201 user data is stored in one or more databases of the integration platform.

At step 1202 an external event is received from an external computer system.

At step 1203 the integration platform determines whether data corresponding to the external event is consistent with the user data in the one or more databases.

At step 1204 one or more alerts are transmitted based at least in part on a determination that the data corresponding to the external event is inconsistent with the user data in the one or more databases.

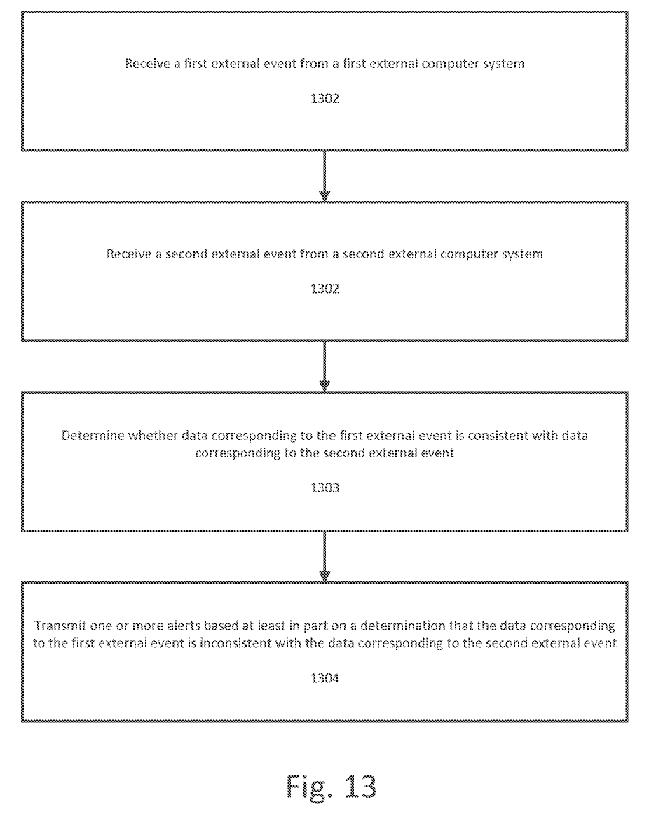

FIG. 13 illustrates another flowchart for consistency validation and alerting according to an exemplary embodiment. The steps shown in FIG. 13 are performed by the integration platform.

At step 1301 a first external event is received from the first entity computer system.

At step 1302 a second external event is received from the second entity computer system.

At step 1303 the integration platform determines whether data corresponding to the first external event is consistent with data corresponding to the second external event.

At step 1304 one or more alerts are transmitted based at least in part on a determination that the data corresponding to the first external event is inconsistent with the data corresponding to the second external event.

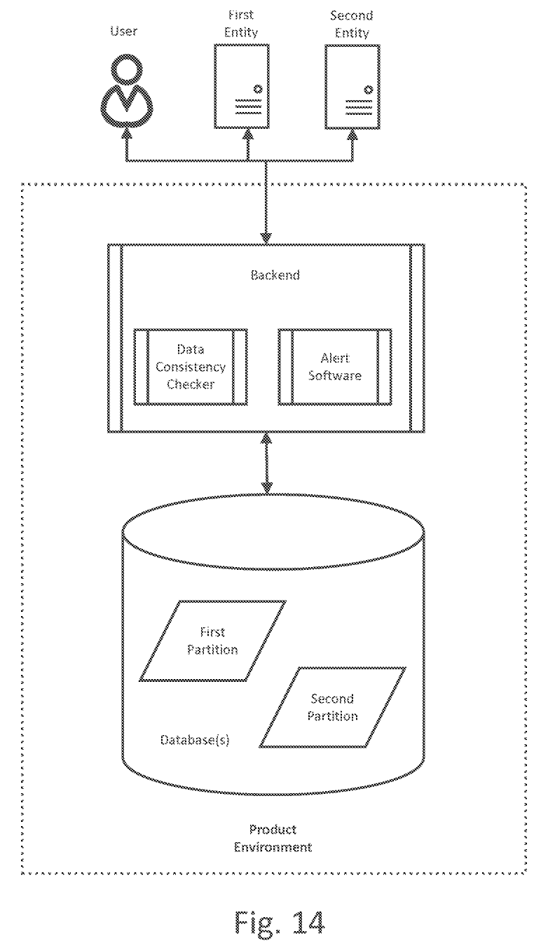

FIG. 14 illustrates a system chart showing the data consistency and alerting functionality of the database according to an exemplary embodiment. The components of the integration platform shown in FIG. 14 include only those components relevant to consistency validation and alerting functionality. It is understood that the integration platform can include additional components not shown in FIG. 14, such as any of the components shown in FIGS. 1A- 1B.

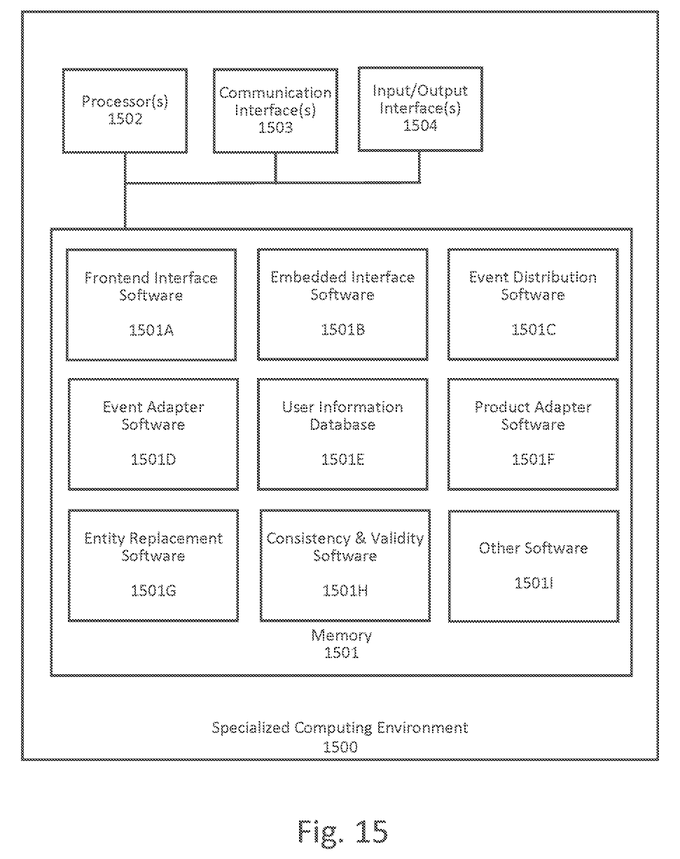

One or more of the above-described techniques can be implemented in or involve one or more special-purpose computer systems having computer-readable instructions loaded thereon that enable the computer system to implement the above-described techniques. FIG. 15 illustrates the specialized computing environment 1500 of the integration platform that is used to perform the above-described methods and implement the above-described systems according to an exemplary embodiment.

With reference to FIG. 15, the computing environment 1500 includes at least one processing unit/controller 1502 and memory 1501. The processing unit 1502 executes computer-executable instructions and can be a real or a virtual processor. In a multi- processing system, multiple processing units execute computer-executable instructions to increase processing power. The memory 1501 can be volatile memory (e.g., registers, cache, RAM), non-volatile memory (e.g., ROM, EEPROM, flash memory, etc.), or some combination of the two. The memory 1501 can store software implementing the above-described techniques, including frontend interface software 1501A, embedded interface software 1501B, event distribution software 1501C, event adapter software 1501D, user information database 1501E, product adapter software 1501F entity replacement software 1501G, consistency and validity software 1501H, and any other software 1501I required to performed the described processes.

All of the software stored within memory 1501 can be stored as a computer- readable instructions, that when executed by one or more processors 1502, cause the processors to perform the functionality described with respect to FIGS. 1-14.

Processor(s) 1502 execute computer-executable instructions and can be a real or virtual processors. In a multi-processing system, multiple processors or multicore processors can be used to execute computer-executable instructions to increase processing power and/or to execute certain software in parallel.

Specialized computing environment 1500 additionally includes a communication interface 1503, such as a network interface, which is used to communicate with devices, applications, or processes on a computer network or computing system, collect data from devices on a network, such as a borrower computer system, a lender computer system, a servicer computer system, or other network systems, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1500 further includes input and output interfaces 1504 that allow users (such as system administrators) to provide input to the system to set parameters, to edit data stored in memory 1501, or to perform other administrative functions.

An interconnection mechanism (shown as a solid line in FIG. 15), such as a bus, controller, or network interconnects the components of the specialized computing environment 1500.

Input and output interfaces 1504 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1500.

Specialized computing environment 1500 can additionally utilize a removable or non-removable storage, such as magnetic disks, magnetic tapes or cassettes, CD-ROMs, CD- RWs, DVDs, USB drives, or any other medium which can be used to store information and which can be accessed within the specialized computing environment 1500.

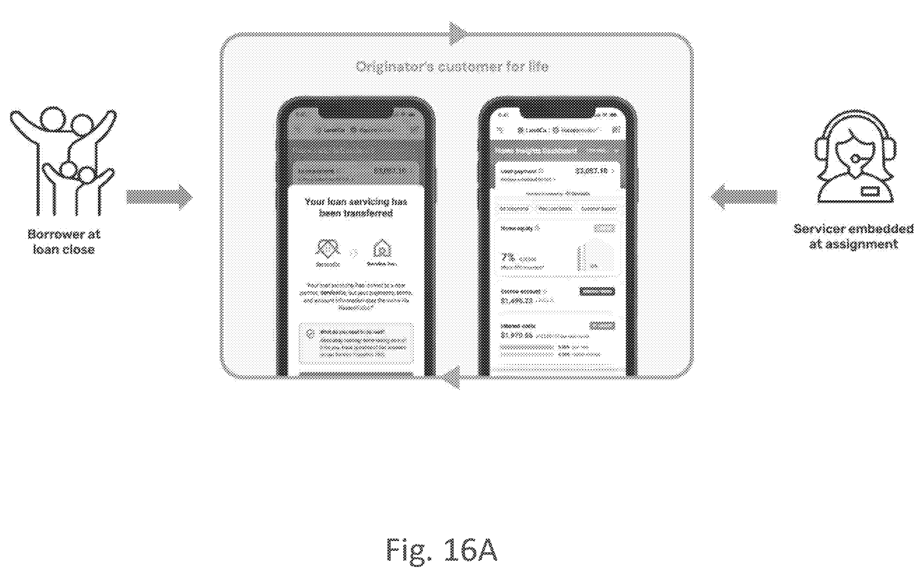

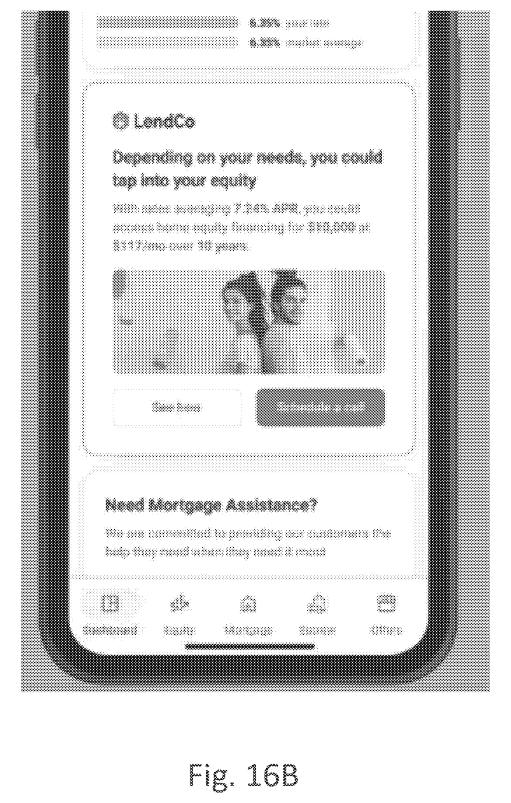

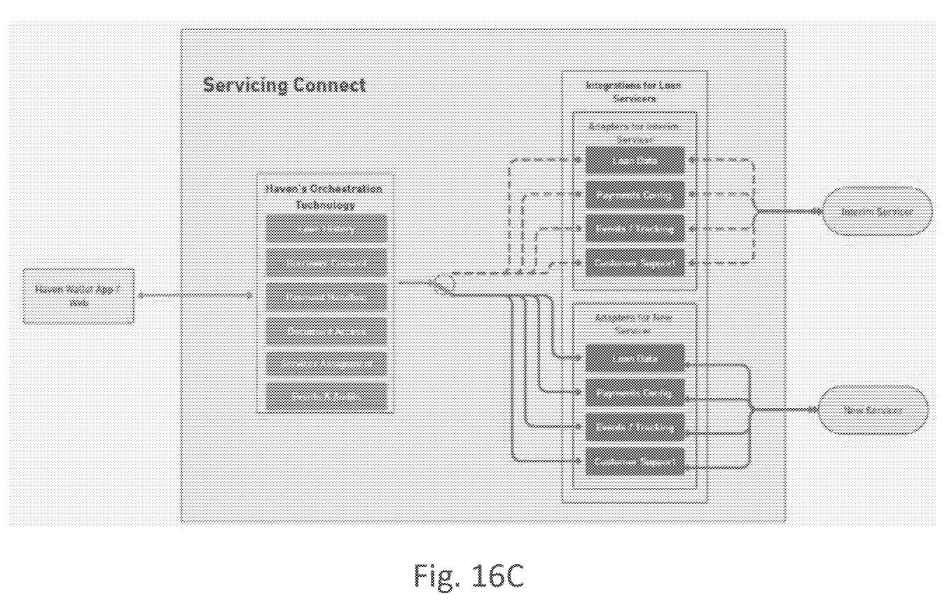

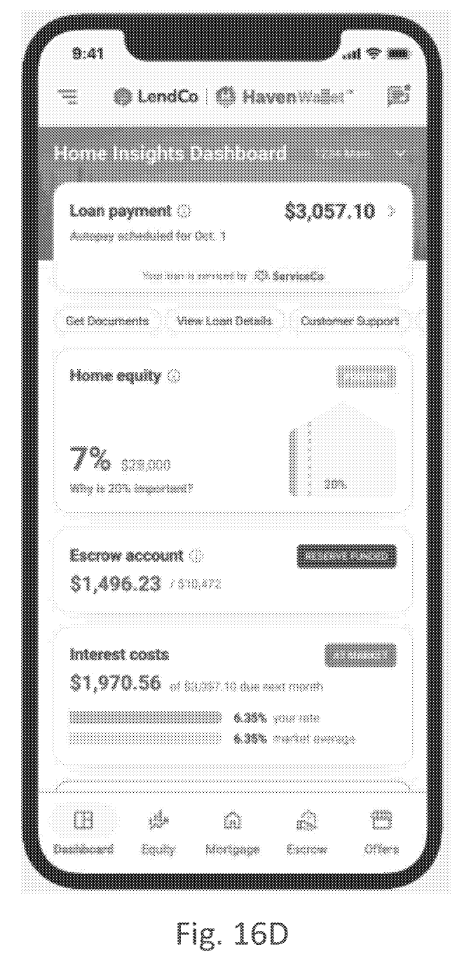

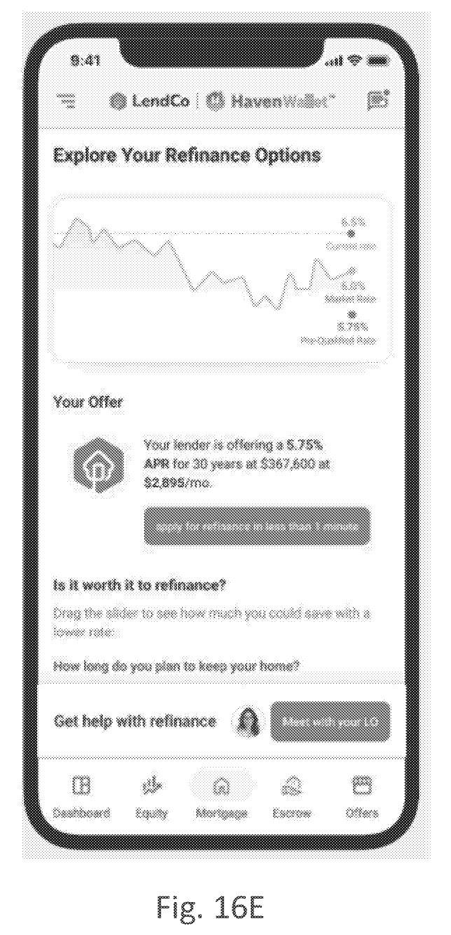

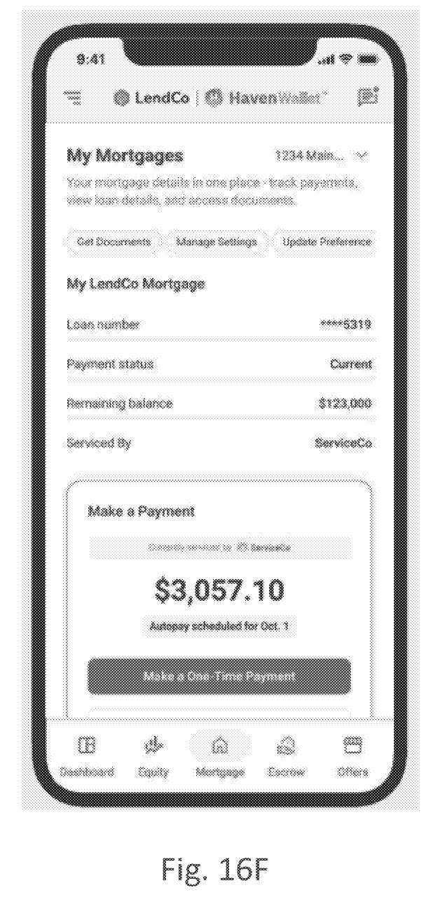

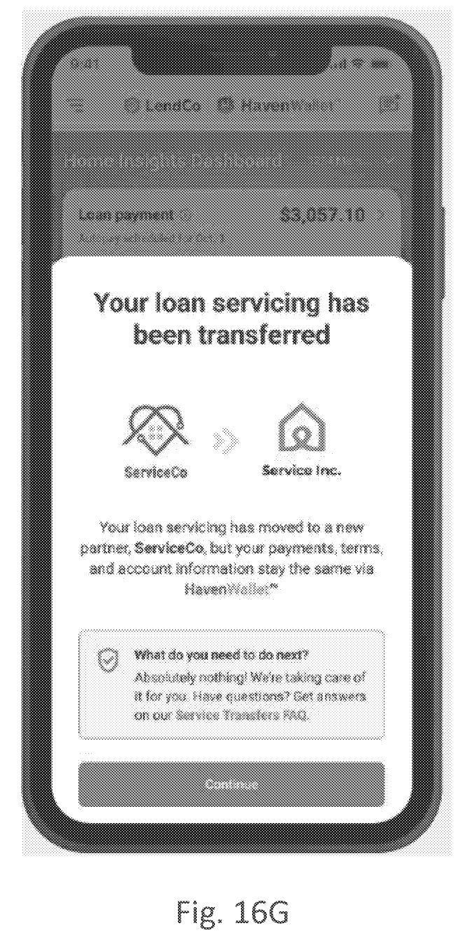

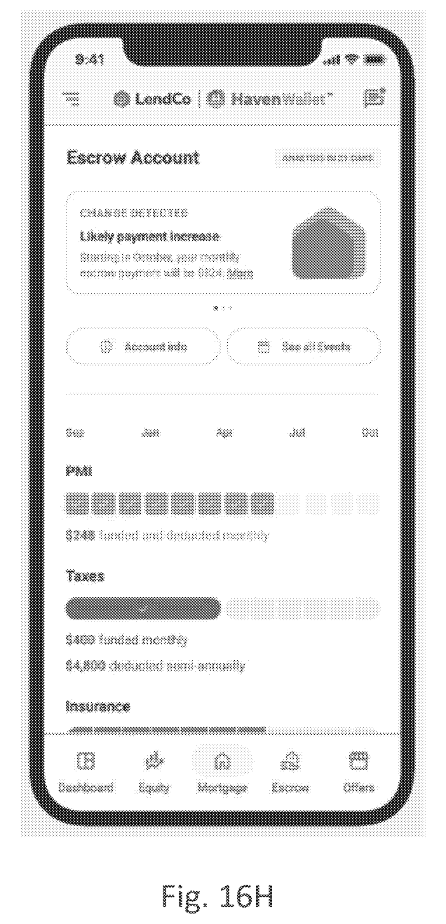

As discussed above, the present methods, systems, and computer-readable media of the integration platform can be implemented in the context of a loan servicing and management platform used by borrowers, lenders, and servicers, referred to as the Haven Platform. FIGS. 16A-16H illustrate example screenshots and diagrams of the Haven Platform according to an exemplary embodiment. The disclosure below outlines six detailed processes that can be implemented as part of the Haven Platform. These processes demonstrate how the present integration platform (implement as the Haven Platform) facilitates seamless integration and collaboration between servicers and originators (lenders) in the mortgage industry while ensuring compliance with regulations such as RESPA (Real Estate Settlement Procedures Act). A key feature across these processes is the centralization of borrower data and documents into a single accessible platform, regardless of servicing transfers. The processes are:

Setting up a servicer and integrating them via an adapter into the orchestration technology.

Setting up an originator and integrating them via an adapter into the orchestration technology.

Using Haven Wallet technology to embed a servicer within the lender brand while maintaining a separation between lender and servicer functions for RESPA compliance.

Facilitating a refinance with MSR (Mortgage Servicing Rights) option through Haven's platform.

Tracking and auditing the refinance process across integrated originators and servicers to ensure performance and compliance.

Using multiple integrated servicer adapters to create a seamless embedded servicing transfer for the borrower.

Each of the processes are now described in greater detail.

### Process 1: Setting Up a Servicer and Integrating Them via an Adapter into Our Orchestration Technology

Overview: This process outlines how a servicer (MSR buyer) is onboarded and integrated into Haven's orchestration platform using a specialized adapter, enabling seamless communication, data exchange, and centralized data storage for borrower access.

### Steps

### Initial Engagement and Onboarding

1.1. Servicer Registration:

The servicer expresses interest in joining the Haven platform.

Collect necessary information about the servicer, including company details, servicing systems used, compliance certifications, and technical capabilities.

1.2. Compliance Verification:

Verify the servicer's compliance with industry regulations (e.g., RESPA, GDPR, CCPA).

Execute Non-Disclosure Agreements (NDAs) and Service-Level Agreements (SLAs).

### Technical Assessment

2.1. System Compatibility Analysis:

Assess the servicer's existing servicing platform and technology stack.

Identify the data formats, protocols, and APIs used by the servicer.

2.2. Define Integration Requirements:

Determine the scope of integration, including data points to be exchanged, frequency of updates, and required functionalities.

### Adapter Development

3.1. Design Custom Adapter:

Design an adapter that acts as an intermediary between the servicer's system and Haven's orchestration platform.

Ensure the adapter can handle data translation, protocol conversion, and secure communication.

3.2. Develop and Configure Adapter:

Develop the adapter using appropriate programming languages and frameworks.

Configure settings to map the servicer's data fields to Haven's standardized data model.

### Security and Compliance Setup

4.1. Implement Data Security Measures:

Ensure data encryption during transmission (e.g., using TLS/SSL).

Set up authentication and authorization mechanisms (e.g., API keys, OAuth tokens).

4.2. Compliance Checks:

Incorporate compliance controls within the adapter to enforce data privacy regulations.

Implement logging and audit trails for data access and modifications.

4.3. Data Centralization Configuration:

Configure the adapter to facilitate the centralization of borrower data and documents within Haven's platform.

Ensure that all relevant borrower information, payment history, and documents are synchronized to Haven's centralized repository.

### Testing and Validation

5.1. Integration Testing:

Perform end-to-end testing to verify that data flows correctly between the servicer's system and Haven's platform.

Test various scenarios, including normal operations, exceptions, and error handling.

5.2. Performance Testing:

Assess the adapter's performance under expected load conditions.

Optimize for scalability and responsiveness.

### Deployment

6.1. Production Rollout:

Deploy the adapter in the production environment.

Schedule deployment during a maintenance window to minimize impact.

6.2. Go-Live Support:

Monitor the integration closely during the initial period.

Provide support for any issues or adjustments needed.

### Ongoing Maintenance

7.1. Continuous Monitoring:

Set up monitoring tools to track adapter performance and data integrity.

Establish alerts for any anomalies or failures.

7.2. Updates and Enhancements:

Periodically update the adapter to accommodate changes in the servicer's systems or regulatory requirements.

Implement new features as needed.

### Process 2: Setting Up an Originator and Integrating Them via an Adapter into Our Orchestration Technology

Overview: This process details how an originator (lender) is onboarded and connected to Haven's orchestration platform through a tailored adapter, enabling secure data exchange, collaboration, and centralization of borrower data and documents.

### Steps

### Initial Engagement and Onboarding

1.1. Originator Registration:

The originator agrees to join the Haven platform.

Collect essential information about the originator, including company details, Loan Origination Systems (LOS) used, compliance certifications, and technical infrastructure.

1.2. Compliance Verification:

Verify the originator's compliance with relevant regulations.

Sign NDAs and SLAs as necessary.

### Technical Assessment

2.1. System Compatibility Analysis:

Evaluate the originator's existing systems, including LOS, CRM, and any proprietary platforms.

Identify data formats, communication protocols, and integration points.

2.2. Define Integration Requirements:

Determine the scope, including necessary data exchanges, transaction types, and integration touchpoints.

### Adapter Development

3.1. Design Custom Adapter:

Design an adapter to interface between the originator's systems and Haven's platform.

Ensure the adapter handles data mapping, protocol translation, and secure communication.

3.2. Develop and Configure Adapter:

Build the adapter using suitable technologies.

Configure data mappings to align the originator's data structures with Haven's standardized model.

### Security and Compliance Setup

4.1. Implement Data Security Measures:

Ensure secure data transmission and storage.

Set up robust authentication and authorization controls.

4.2. Compliance Controls:

Embed compliance features to manage borrower consents and data privacy.

Implement audit logs and access tracking.

4.3. Data Centralization Configuration:

Configure the adapter to facilitate the centralization of borrower data and documents within Haven's platform.

Ensure that all relevant borrower information, payment history, and documents are synchronized to Haven's centralized repository.

### Testing and Validation

5.1. Integration Testing:

Test the adapter to ensure accurate and reliable data exchange.

Validate all functional requirements and error handling mechanisms.

5.2. Performance Testing:

Test for scalability and performance under expected usage.

Optimize for scalability and responsiveness.

### Deployment

6.1. Production Deployment:

Deploy the adapter to the live environment.

Coordinate with the originator to minimize disruptions.

6.2. Support and Monitoring:

Provide immediate support during the initial phase.

Monitor integration performance and address issues promptly.

### Ongoing Maintenance

7.1. Continuous Monitoring:

Implement monitoring tools for ongoing oversight.

Set up alerts for any discrepancies or failures.

7.2. Updates and Enhancements:

Update the adapter as needed for system changes or new requirements.

Enhance features based on feedback and evolving needs.

### Process 3: Using Haven Wallet Technology to Embed a Servicer Within the Lender Brand While Maintaining Separation Between Lender and Servicer Functions for RESPA Compliance

Overview: This process explains how Haven Wallet technology enables the integration of servicer functionalities into the lender's branded platform, ensuring RESPA compliance by maintaining appropriate separation between lender and servicer roles. When the borrower logs into the lender's platform, they see offers from the lender clearly separated from the embedded servicing areas, ensuring that the servicer is not referring the borrower to the lender. Lender offers may use servicing data with the borrower's permission, and these permissions are tracked and accounted for by Haven's platform. Additionally, Haven centralizes borrower data and documents, providing a single access point regardless of servicing changes.

### Steps

### Platform Integration Setup

1.1. Integration Planning:

Collaborate with the lender to plan the integration of servicing functionalities into their platform.

Identify the features to be embedded (e.g., account management, payment processing).

1.2. Branding Alignment:

Ensure the user interface reflects the lender's branding guidelines.

Customize visual elements to maintain brand consistency.

### Separation of Functions

2.1. Functional Segregation:

Use Haven Wallet's architecture to separate lender and servicer functions logically and technically.

Implement role-based access controls to prevent unauthorized access to each other's data.

2.2. Data Partitioning:

Partition data to ensure that the lender does not have access to servicer-only information and vice versa.

Use data anonymization where appropriate to protect sensitive information.

### Compliance Mechanisms Implementation

3.1. RESPA Compliance Controls:

Embed compliance rules within the platform to enforce RESPA regulations.

Prevent practices like kickbacks or unearned fees between lender and servicer.

3.2. Advertising Controls:

Ensure that any refinancing advertisements or offers presented to the borrower are compliant.

Offers from the lender are clearly separated from the embedded servicing areas to ensure clarity.

The servicer does not refer the borrower to the lender; instead, the lender presents offers directly within their sections of the platform.

### Embedding Servicer Functions via Haven Wallet

4.1. Functionality Integration:

Embed servicer functionalities (e.g., loan servicing details, payment history) into the lender's platform through Haven Wallet.

Use APIs to securely pull servicer data into the lender-branded interface.

4.2. User Interface Design:

Design the interface to display servicer information seamlessly within the lender's platform.

Ensure a consistent user experience without exposing backend integrations.

### Centralization of Borrower Data and Documents

5.1. Unified Access Point:

Utilize Haven's centralized data repository to present the borrower with all their loan information and documents in one place.

Include historical data and documents from previous servicers, if applicable.

5.2. Data Synchronization:

Ensure real-time synchronization of borrower data and documents between the servicer, lender, and Haven's central repository.

Provide continuous access to account statements, payment history, escrow analyses, and other relevant documents.

### Presentation of Lender Offers

6.1. Separate Display Areas:

Clearly separate lender offers from servicing functionalities within the platform.

Use distinct sections or tabs labeled appropriately (e.g., "Your Loan Servicing" vs. "Offers from [Lender]").

6.2. Servicing Data Utilization with Permission:

With the borrower's permission, the lender may use servicing data to personalize offers.

Implement mechanisms for the borrower to grant or revoke permissions easily.

### Borrower Consent and Permissions Management

7.1. Consent Capture:

Obtain explicit borrower consent for using servicing data to present offers.

Provide clear explanations of how the data will be used.

7.2. Permission Tracking:

Use Haven's platform to track and account for borrower permissions.

Ensure that permissions are enforced across all systems and interactions.

### Security and Data Privacy

8.1. Secure Data Handling:

Encrypt data in transit and at rest.

Implement strong authentication mechanisms for borrower access.

8.2. Privacy Compliance:

Comply with data privacy regulations by ensuring borrower data is handled appropriately.

Provide borrowers with access to privacy policies and options to manage their data.

### Testing and Validation

9.1. Compliance Testing:

Conduct thorough testing to ensure all functionalities comply with RESPA and other regulations.

Test scenarios for potential compliance breaches.

9.2. User Acceptance Testing:

Involve borrower focus groups to test the interface and functionality.

Gather feedback to refine the user experience.

### Deployment and Monitoring

10.1. Go-Live Deployment:

Launch the integrated platform to borrowers.

Ensure all systems are functioning correctly.

10.2. Ongoing Compliance Monitoring:

Monitor platform activities to detect and address any compliance issues promptly.

Regularly update compliance rules as regulations evolve.

### Process 4: Facilitating a Refinance with MSR Option Through Haven's Platform

Overview: This process details how Haven's platform facilitates a refinance transaction involving an MSR Option Agreement between an originator (lender) and an MSR buyer (servicer). The platform ensures seamless execution, compliance, centralized data access, and an uninterrupted borrower experience.

### Steps

### Original Loan Servicing

1.1. MSR Ownership and Servicing

1.1.1. MSR Buyer Ownership:

The MSR buyer owns the servicing rights to the borrower's original mortgage loan.

The borrower makes mortgage payments to the MSR buyer, who manages servicing tasks such as payment processing, escrow management, and customer service.

1.1.2. Data Integration:

The servicer's systems are integrated with Haven's platform via an adapter (as per Process 1), enabling real-time data exchange and monitoring.

### Borrower Decides to Refinance

2.1. Trigger Event Identification

2.1.1. Rate Monitoring:

Haven's rate monitoring tools analyze market interest rates and borrower profiles to identify refinancing opportunities.

2.1.2. Candidate Selection:

The borrower is flagged as a candidate for refinancing due to potential savings or the need to adjust loan terms.

2.2. Borrower Engagement Preparation

2.2.1. Consent Verification:

Confirm that the borrower has provided consent to receive refinancing offers (managed through Haven's borrower consent module).

### Originator Initiates Recapture Effort

3.1. Personalized Offer Creation

3.1.1. Data Analysis:

The originator uses data insights provided by Haven to tailor a personalized refinancing offer.

3.1.2. Offer Generation:

Create a refinancing proposal outlining new loan terms, potential savings, and benefits.

3.2. Borrower Communication

3.2.1. Embedded Servicing Platform:

The originator reaches out to the borrower through the Haven Wallet embedded within the lender's branded platform.

3.2.2. Compliance Assurance:

Ensure all communications comply with data privacy laws and respect borrower consents.

### Borrower Agrees to Refinance

4.1. Loan Application Process

4.1.1. Application Initiation:

The borrower accepts the offer and begins the refinancing application within the lender's platform.

4.1.2. Document Collection:

Haven's platform facilitates the secure collection of necessary documentation and information from the borrower.

4.2. Application Processing

4.2.1. Underwriting Integration:

The originator's Loan Origination System (LOS) processes the application, integrated with Haven's platform for data consistency.

4.2.2. Status Updates:

Provide real-time updates to the borrower on application status via the platform.

### Execution of MSR Option Agreement

5.1. MSR Option Activation

5.1.1. Agreement Verification:

Haven's Recapture and MSR Option Tracking Module confirms the existence and terms of the MSR Option Agreement between the originator and MSR buyer.

5.1.2. Notification to MSR Buyer:

Upon the borrower's commitment to refinance, the originator notifies the MSR buyer through Haven's platform.

5.2. MSR Option Exercise

5.2.1. Option Execution:

The MSR buyer elects to exercise their option to purchase the MSR of the new loan under pre-agreed terms.

5.2.2. Agreement Documentation:

Record the execution of the option within the platform, ensuring all legal and compliance requirements are met.

### Origination of the New Loan

6.1. Loan Finalization

6.1.1. Approval and Closing:

The originator completes the underwriting process, approves the loan, and schedules closing.

6.1.2. Payoff of Original Loan:

The proceeds from the new loan are used to pay off the original loan, effectively closing it.

6.2. Data Updates

6.2.1. System Synchronization:

Update all relevant systems (originator's LOS, MSR buyer's servicing platform) via Haven's adapters to reflect the new loan status.

### Sale of New MSR to MSR Buyer

7.1. MSR Transaction Execution

7.1.1. MSR Sale Processing:

The originator sells the MSR of the new loan to the MSR buyer as per the MSR Option Agreement.

7.1.2. Financial Settlement:

The MSR buyer pays the originator the agreed-upon price for the new MSR.

7.2. Documentation and Compliance

7.2.1. Transaction Recording:

Record the MSR sale within Haven's platform, ensuring transparency and auditability.

7.2.2. Compliance Checks:

Verify that the transaction complies with all regulatory requirements and internal policies.

### Seamless Servicing Transfer

8.1. Borrower Experience Management

8.1.1. Continuity of Service:

Haven's seamless servicing transfer technology ensures the borrower continues to interact with the same servicer without noticing any changes.

8.1.2. Communication:

If required, send compliant notifications to the borrower about the refinancing and servicing arrangements.

8.2. Data Consistency and Centralization

8.2.1. Data Migration:

Transfer necessary servicing data from the originator to the MSR buyer securely.

8.2.2. Centralized Access Maintenance:

Ensure that all borrower information and documents remain centralized within Haven's platform, providing uninterrupted access to historical and current data.

### Data Privacy and Compliance

9.1. Regulatory Adherence

9.1.1. Data Handling Compliance:

Throughout the process, Haven manages data securely, adhering to regulations like RESPA, GDPR, and CCPA.

9.1.2. Consent Management:

Obtain and record borrower consents for all communications and data processing activities.

9.2. Audit and Logging

9.2.1. Activity Logging:

Maintain detailed logs of all actions taken during the refinance process for auditing purposes.

9.2.2. Compliance Reporting:

Generate reports demonstrating compliance with regulatory requirements and internal policies.

### Post-Refinance Servicing

10.1. Ongoing Servicing

10.1.1. Servicing Continuation:

The MSR buyer begins servicing the new loan, maintaining the servicing relationship with the borrower.

10.1.2. Borrower Support and Centralized Access:

Provide ongoing customer service, payment processing, and escrow management as before.

Borrower continues to access all loan information and documents through the centralized Haven platform.

10.2. Originator's Continued Relationship

10.2.1. Relationship Management:

The originator retains the borrower relationship for future opportunities, such as cross-selling financial products.

10.2.2. Data Updates:

Update the borrower's profile in the originator's CRM system to reflect the new loan and servicing arrangements.

### Performance Tracking and Feedback

11.1. Monitoring Outcomes

11.1.1. Recapture Rate Analysis:

Use Haven's analytics tools to assess the effectiveness of the recapture effort.

11.1.2. Borrower Satisfaction:

Gather borrower feedback on the refinancing and servicing experience.

11.2. Continuous Improvement

11.2.1. Process Optimization:

Identify areas for improvement in the refinancing process based on data insights.

11.2.2. Platform Enhancements:

Implement enhancements to Haven's platform to streamline future transactions.

### Process 5: Tracking and Auditing the Refinance Process Across Integrated Originators and Servicers to Ensure Performance and Compliance

Overview: This process outlines how Haven tracks and audits the refinance process involving integrated originators and servicers, ensuring that all parties adhere to agreements (e.g., servicer's rights to the refinanced MSR) and maintain compliance. Centralized data and document storage facilitate efficient auditing and transparency.

### Steps

### Establishing Audit Framework

1.1. Define Audit Requirements:

Identify the key compliance requirements and performance metrics to be tracked.

Determine the data points necessary for auditing.

1.2. Implement Tracking Mechanisms:

Configure the platform to monitor relevant activities, including loan statuses, MSR transactions, and borrower communications.

### Monitoring Refinance Activities

2.1. Activity Logging:

Log all refinance-related activities initiated by the originator.

Include timestamps, user actions, and data changes.

2.2. MSR Option Enforcement:

Track MSR Option Agreements to ensure that when a borrower refinances, the servicer's rights are respected.

### Compliance Verification

3.1. Automated Checks:

Implement automated checks to detect potential breaches, such as the originator attempting to sell the refinanced MSR to another party.

3.2. Alert Mechanisms:

Configure alerts to notify relevant parties when an action may violate agreements or regulations.

### Data Integrity and Security

4.1. Secure Data Handling:

Ensure that all data related to the refinance process is handled securely and in compliance with data privacy laws.

4.2. Access Controls:

Restrict access to sensitive information based on user roles and permissions.

4.3. Centralized Data Repository:

Utilize the centralized storage of borrower data and documents to facilitate efficient auditing and verification processes.

### Regular Audits and Reporting

5.1. Scheduled Audits:

Conduct regular audits of the refinance transactions and related activities.

Use audit logs to verify compliance with agreements and regulations.

5.2. Reporting:

Generate reports for internal review and for sharing with servicers and originators as needed.

Include key metrics, compliance status, and any incidents.

### Issue Resolution Process

6.1. Incident Management:

Establish a process for handling incidents where non-compliance is detected.

Include steps for investigation, resolution, and documentation.

6.2. Remediation Actions:

Define corrective actions to be taken in case of breaches, such as reversing unauthorized transactions.

### Maintaining Transparency with Parties

7.1. Communication Protocols:

Keep servicers and originators informed about the status of refinances and MSR transactions.

7.2. Access to Audit Trails:

Provide authorized parties with access to relevant audit logs and reports.

### Continuous Improvement

8.1. Feedback Loop:

Collect feedback from users on the tracking and auditing processes.

8.2. Process Enhancements:

Update tracking and auditing mechanisms based on feedback and changes in regulations.

### Compliance with Legal and Regulatory Standards

9.1. Legal Review:

Ensure that all tracking and auditing practices comply with applicable laws.

9.2. Regulatory Updates:

Stay informed about changes in regulations that may affect compliance requirements.

### Process 6: Using Multiple Integrated Servicer Adapters to Create a Seamless Embedded Servicing Transfer for the Borrower

Overview: This process describes how Haven uses integrated servicer adapters to manage servicing transfers between servicers without interrupting the borrower's access to services, ensuring continuous availability of information and documents. It includes the initial setup where borrower payment details and preferences are captured, along with consent and authorization from the borrower to store and transfer these details to future incoming servicers on their behalf. Centralization of data and documents across multiple servicing transfers ensures the borrower has a single access point for all their mortgage information.

### Steps

### Integration of Multiple Servicer Adapters

1.1. Adapter Network Setup:

Develop and deploy adapters for each servicer integrated into Haven's platform.

Ensure each adapter adheres to a standardized data model for interoperability.

### Initial Borrower Setup

2.1. Capturing Borrower Payment Details and Preferences:

2.1.1. Payment Information Collection:

During initial onboarding, the borrower provides their payment details (e.g., bank account information, preferred payment methods).

Capture payment preferences such as payment schedules, autopay settings, and notification preferences.

2.1.2. Consent and Authorization:

Present clear and concise consent forms to the borrower, explaining how their payment details and preferences will be used.

Obtain explicit authorization from the borrower to securely store their payment information and transfer it to future incoming servicers on their behalf in the event of a servicing transfer.

2.1.3. Secure Storage and Centralization:

Store the payment details, preferences, and other borrower data securely within Haven's centralized platform, using encryption and access controls to protect sensitive information.

2.2. Consent Management and Compliance:

2.2.1. Consent Recording:

Record and timestamp all borrower consents and authorizations.

Ensure that consent records are easily retrievable for compliance verification.

2.2.2. Regulatory Compliance:

Ensure that the collection and storage of payment details comply with data privacy regulations such as GDPR and CCPA.

Provide the borrower with options to view, update, or revoke their consents and preferences.

### Pre-Transfer Preparation

3.1. Transfer Initiation:

Upon notification of an impending servicing transfer, begin preparations in coordination with both the outgoing and incoming servicers.

3.2. Data Synchronization Planning:

Plan for data synchronization to ensure all borrower data, including payment details and preferences, are up-to-date across both servicers.

### Data Migration and Synchronization

4.1. Secure Data Transfer:

4.1.1. Payment Details Transfer:

Use the integrated adapters to securely transfer the borrower's stored payment details and preferences to the incoming servicer.

Ensure that the transfer process maintains data encryption and integrity.

4.1.2. Comprehensive Data Sharing:

Include loan information, payment history, escrow balances, and any other relevant data in the transfer.

4.2. Reconciliation and Validation:

Validate data accuracy post-transfer.

Reconcile any discrepancies promptly to prevent issues with payment processing.

### Centralization of Data and Documents

5.1. Continuous Centralized Access:

Ensure that all borrower data and documents, including those from previous servicers, remain centralized within Haven's platform.

Provide the borrower with uninterrupted access to their entire mortgage history, regardless of servicing changes.

5.2. Data Synchronization:

Synchronize data between the incoming servicer and Haven's central repository to keep information current.

### Maintaining Borrower Access and Continuity

6.1. Consistent Borrower Interface:

Through Haven Wallet, ensure the borrower continues to access their account via the lender-branded platform without requiring further action.

6.2. Payment Processing Continuity:

Ensure that the borrower's payment settings (e.g., autopay) continue without interruption.

Coordinate with the incoming servicer to confirm that scheduled payments proceed as authorized.

6.3. Document Availability:

Provide access to historical and current documents, including statements, escrow analyses, and tax forms, through the centralized platform.

### Communication Management

7.1. Notification Strategy:

Develop compliant communication to inform the borrower of the servicing transfer as required by regulations.

Use clear, reassuring language to minimize borrower concern, emphasizing that their payment details and preferences have been securely transferred.

7.2. Centralized Messaging:

Utilize Haven's messaging system to manage communications, ensuring consistency.

Provide contact information for support if the borrower has questions.

### Seamless Transition Execution

8.1. Cutover Coordination:

Coordinate the exact timing of the transfer to ensure no service interruption.

Both servicers update their systems simultaneously through the adapters.

8.2. Real-Time Updates:

Provide real-time updates to the borrower regarding their account status, if necessary.

Confirm that payment methods and schedules are active and accurate.

### Post-Transfer Support

9.1. Monitoring and Issue Resolution:

Monitor borrower accounts for any post-transfer issues, particularly related to payments.

Address any borrower inquiries promptly, with a focus on resolving payment- related concerns.

9.2. Continuous Access Assurance:

Ensure that borrowers continue to have uninterrupted access to make payments, view statements, and perform other account activities.

### Compliance and Audit Logging

10.1. Record Keeping:

Maintain detailed logs of all actions taken during the transfer, including consents and data transfers.

Ensure logs meet regulatory requirements for auditing.

10.2. Compliance Verification:

Review the transfer process to confirm compliance with all relevant regulations, focusing on data privacy and borrower authorizations.

### Conclusion

By integrating these processes into our patent application, we showcase Haven's unique technological solutions in the mortgage servicing industry. These processes highlight:

Integration and Collaboration: Effective onboarding of servicers and originators, enabling secure and seamless data exchange.

Regulatory Compliance: Ensuring RESPA compliance through function separation, borrower consent management, and compliance controls.

Enhanced Borrower Experience: Providing a consistent and uninterrupted borrower experience during servicing transfers and refinancing, with secure handling of payment details and preferences.

Data Centralization: Centralizing borrower data and documents across multiple servicing transfers into a single accessible platform, ensuring continuous access and transparency.

Transparency and Accountability: Tracking and auditing mechanisms that ensure adherence to agreements and regulatory standards.

Haven's platform revolutionizes mortgage servicing by enabling lenders and servicers to collaborate effectively while maintaining compliance and enhancing borrower satisfaction through centralized data management.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices of an integration platform for bidirectional communication with heterogenous networked systems via an integrated frontend interface, the method comprising:
transmitting, by the integration platform, a frontend interface for display to a user, the frontend interface comprising a first interface corresponding to a first entity computer system on a computer network, wherein the integration platform is configured to expose one or more first functionalities mapped to the first entity computer system to the user via the first interface;
embedding, by the integration platform, a second interface within the frontend interface, the second interface corresponding to a second entity computer system on the computer network, wherein the integration platform is configured to expose one or more second functionalities mapped to the second entity computer system to the user via the second interface, wherein the second interface is distinct from the first interface, and wherein the first entity computer system and the second entity computer system comprise distinct entities on the computer network;
detecting, by the integration platform, an event in the second interface of the frontend interface;
determining, by the integration platform, that the event corresponds to the second entity computer system based at least in part on detecting the event in the second interface of the frontend interface;
transforming, by the integration platform, the event into a second entity event that is interpretable by the second entity computer system, wherein a second entity adapter is configured to transform events in the second interface into corresponding second entity events on the second entity computer system; and
transmitting, by the integration platform, the second entity event to the second entity computer system over the computer network.

2. The method of claim 1, further comprising:
receiving, by the integration platform, an external event from an external computer system;
identifying, by the integration platform, an external event adapter in a plurality of external event adapters based at least in part on the identity of external computer system;
transforming, by the integration platform, the external event into one or more native events with the identified external event adapter, the one or more native events being configured to update a state of the integration platform; and
updating, by the integration platform, the state of the integration platform based at least in part on the one or more native events.

3. The method of claim 2, wherein the external computer system comprises one of the first entity computer system or the second entity computer system.

4. The method of claim 2, wherein the external computer system comprises the second entity computer system and wherein the external event is received from the second entity computer system in response to the second entity event transmitted to the second entity computer system.

5. The method of claim 2, wherein updating the state of the integration platform based at least in part on the one or more native events comprises updating one or more records corresponding to the user in one or more databases of the integration platform based at least in part on the one or more native events.

6. The method of claim 2, wherein updating the state of the integration platform based at least in part on the one or more native events comprises updating the frontend interface based at least in part on the one or more native events.

7. The method of claim 6, wherein the external computer system comprises the second entity computer system and wherein updating the frontend interface based at least in part on the one or more native events comprises updating the second interface of the frontend interface based at least in part on the one or more native events.

8. The method of claim 2, wherein the external event comprises a replacement event configured to replace the second entity computer system with a third entity computer system on the computer network and wherein updating the state of the integration platform based at least in part on the one or more native events comprises:
reconfiguring the embedded second interface to correspond to the third entity computer system, such that the exposed one or more second functionalities within the second interface are mapped to the third entity computer system rather than the second entity computer system.

9. The method of claim 8, wherein updating the state of the integration platform based at least in part on the one or more native events further comprises:
retrieving user data corresponding to the user from the third entity computer system via a third entity external event adapter in the plurality of external event adapters; and
storing user data in one or more databases of the integration platform.

10. The method of claim 8, further comprising:
retrieving, by the integration platform, user settings data from one or more databases of the integration platform, the user settings data corresponding to the user and second entity computer system;
transmitting, by the integration platform, one or more instructions to the third entity computer system based at least in part on the user settings data.

11. The method of claim 1, further comprising:
retrieving, by the integration platform, a first set of user data corresponding to the user from the first entity computer system via a first entity external event adapter in the plurality of external event adapters;
retrieving, by the integration platform, a second set of data corresponding to the user from the second entity computer system via a second entity external event adapter in the plurality of external event adapters;
storing, by the integration platform, the first set of data and the second set of data in one or more databases of the integration platform.

12. The method of claim 11, further comprising:
partitioning, by the integration platform, the first set of data and the second set of data into a first partition and a second partition within the one or more databases of the integration platform; and
executing, by the integration platform, a role-based access control scheme, the role-based access control scheme being configured to control access to the first partition and the second partition based at least in part on an identity of a requesting entity.

13. The method of claim 12, wherein:
at least a portion of the first partition is accessible to the first entity computer system but the second partition is not accessible to first entity computer system;
at least a portion of the second partition is accessible to the second entity computer system but the first partition is not accessible to first entity computer system; and
at least a portion of the first partition and the second partition are accessible to the user.

14. The method of claim 1, further comprising:
detecting, by the integration platform, a second event in the first interface of the frontend interface;
determining, by the integration platform, that the second event corresponds to the first entity computer system based at least in part on detecting the second event in the first interface of the frontend interface;
transforming, by the integration platform, the second event into a first entity event that is interpretable by the first entity computer system, wherein a first entity adapter is configured to transform events in the first interface into corresponding first entity events on the first entity computer; and
transmitting, by the integration platform, the first entity event to the first entity computer system over the computer network.

15. The method of claim 1, further comprising:
storing, by the integration platform, user data in one or more databases of the integration platform;
receiving, by the integration platform, an external event from an external computer system;
determining, by the integration platform, whether data corresponding to the external event is consistent with the user data in the one or more databases; and
transmitting, by the integration platform, one or more alerts based at least in part on a determination that the data corresponding to the external event is inconsistent with the user data in the one or more databases.

16. The method of claim 1, further comprising:
receiving, by the integration platform, a first external event from the first entity computer system;
receiving, by the integration platform, a second external event from the second entity computer system;
determining, by the integration platform, whether data corresponding to the first external event is consistent with data corresponding to the second external event; and
transmitting, by the integration platform, one or more alerts based at least in part on a determination that the data corresponding to the first external event is inconsistent with the data corresponding to the second external event.

17. The method of claim 1, wherein transforming, by a second entity adapter of the integration platform, the event into a second entity event that is interpretable by the second entity computer system comprises:
determining an event type of the event;
identifying the second entity adapter in a plurality of second entity adapters based at least in part on the determined event type, the identified second entity adapter being configured to transform events of the event type into corresponding second entity events of the same event type; and
transforming the event into the second entity event with the identified second entity adapter.

18. The method of claim 1, wherein the frontend interface comprises one of a mobile application or a website.

19. The method of claim 1, wherein frontend interface comprises an interface associated with the first entity.

20. An integration platform for bidirectional communication with heterogenous networked systems via an integrated frontend interface, the integration platform comprising:
one or more processors; and
one or more memories operatively coupled to at least one of the one or more processors and having instructions stored thereon that, when executed by at least one of the one or more processors, cause at least one of the one or more processors to:
transmit a frontend interface for display to a user, the frontend interface comprising a first interface corresponding to a first entity computer system on a computer network, wherein the integration platform is configured to expose one or more first functionalities mapped to the first entity computer system to the user via the first interface;
embed a second interface within the frontend interface, the second interface corresponding to a second entity computer system on the computer network, wherein the integration platform is configured to expose one or more second functionalities mapped to the second entity computer system to the user via the second interface, wherein the second interface is distinct from the first interface, and wherein the first entity computer system and the second entity computer system comprise distinct entities on the computer network;
detect an event in the second interface of the frontend interface;
determine that the event corresponds to the second entity computer system based at least in part on detecting the event in the second interface of the frontend interface;
transform the event into a second entity event that is interpretable by the second entity computer system, wherein a second entity adapter is configured to transform events in the second interface into corresponding second entity events on the second entity computer system; and
transmit the second entity event to the second entity computer system over the computer network.

21. The integration platform of claim 20, wherein at least one of the one or more memories has further instructions stored thereon that, when executed by at least one of the one or more processors, cause at least one of the one or more processors to:
receive an external event from an external computer system;
identify an external event adapter in a plurality of external event adapters based at least in part on the identity of external computer system;
transform the external event into one or more native events with the identified external event adapter, the one or more native events being configured to update a state of the integration platform; and
update the state of the integration platform based at least in part on the one or more native events.

22. The integration platform of claim 21, wherein the external computer system comprises one of the first entity computer system or the second entity computer system.

23. The integration platform of claim 21, wherein the external computer system comprises the second entity computer system and wherein the external event is received from the second entity computer system in response to the second entity event transmitted to the second entity computer system.

24. The integration platform of claim 21, wherein the instructions that, when executed by at least one of the one or more processors, cause at least one of the one or more processors to update the state of the integration platform based at least in part on the one or more native events further cause at least one of the one or more processors to:
update one or more records corresponding to the user in one or more databases of the integration platform based at least in part on the one or more native events.

25. The integration platform of claim 21, wherein the instructions that, when executed by at least one of the one or more processors, cause at least one of the one or more processors to update the state of the integration platform based at least in part on the one or more native events further cause at least one of the one or more processors to:
update the frontend interface based at least in part on the one or more native events.

26. The integration platform of claim 25, wherein the external computer system comprises the second entity computer system and wherein the instructions that, when executed by at least one of the one or more processors, cause at least one of the one or more processors to update the frontend interface based at least in part on the one or more native events further cause at least one of the one or more processors to:
update the second interface of the frontend interface based at least in part on the one or more native events.

27. The integration platform of claim 21, wherein the external event comprises a replacement event configured to replace the second entity computer system with a third entity computer system on the computer network and wherein the instructions that, when executed by at least one of the one or more processors, cause at least one of the one or more processors to update the state of the integration platform based at least in part on the one or more native events further cause at least one of the one or more processors to:
reconfigure the embedded second interface to correspond to the third entity computer system, such that the exposed one or more second functionalities within the second interface are mapped to the third entity computer system rather than the second entity computer system.

28. The integration platform of claim 27, wherein the instructions that, when executed by at least one of the one or more processors, cause at least one of the one or more processors to update the state of the integration platform based at least in part on the one or more native events further cause at least one of the one or more processors to:
retrieve user data corresponding to the user from the third entity computer system via a third entity external event adapter in the plurality of external event adapters; and
store user data in one or more databases of the integration platform.

29. The integration platform of claim 27, wherein at least one of the one or more memories has further instructions stored thereon that, when executed by at least one of the one or more processors, cause at least one of the one or more processors to:
retrieve user settings data from one or more databases of the integration platform, the user settings data corresponding to the user and second entity computer system; and
transmit one or more instructions to the third entity computer system based at least in part on the user settings data.

30. The integration platform of claim 20, wherein at least one of the one or more memories has further instructions stored thereon that, when executed by at least one of the one or more processors, cause at least one of the one or more processors to:
retrieve a first set of user data corresponding to the user from the first entity computer system via a first entity external event adapter in the plurality of external event adapters;
retrieve a second set of data corresponding to the user from the second entity computer system via a second entity external event adapter in the plurality of external event adapters; and
store the first set of data and the second set of data in one or more databases of the integration platform.

31. The integration platform of claim 30, wherein at least one of the one or more memories has further instructions stored thereon that, when executed by at least one of the one or more processors, cause at least one of the one or more processors to:
partition the first set of data and the second set of data into a first partition and a second partition within the one or more databases of the integration platform; and
execute a role-based access control scheme, the role-based access control scheme being configured to control access to the first partition and the second partition based at least in part on an identity of a requesting entity.

32. The integration platform of claim 31, wherein:
at least a portion of the first partition is accessible to the first entity computer system but the second partition is not accessible to first entity computer system;
at least a portion of the second partition is accessible to the second entity computer system but the first partition is not accessible to first entity computer system; and
at least a portion of the first partition and the second partition are accessible to the user.

33. The integration platform of claim 20, wherein at least one of the one or more memories has further instructions stored thereon that, when executed by at least one of the one or more processors, cause at least one of the one or more processors to:
detect a second event in the first interface of the frontend interface;
determine that the second event corresponds to the first entity computer system based at least in part on detecting the second event in the first interface of the frontend interface;
transform the second event into a first entity event that is interpretable by the first entity computer system, wherein a first entity adapter is configured to transform events in the first interface into corresponding first entity events on the first entity computer; and
transmit the first entity event to the first entity computer system over the computer network.

34. The integration platform of claim 20, wherein at least one of the one or more memories has further instructions stored thereon that, when executed by at least one of the one or more processors, cause at least one of the one or more processors to:
store user data in one or more databases of the integration platform;
receive an external event from an external computer system;
determine whether data corresponding to the external event is consistent with the user data in the one or more databases; and
transmit one or more alerts based at least in part on a determination that the data corresponding to the external event is inconsistent with the user data in the one or more databases.

35. The integration platform of claim 20, wherein at least one of the one or more memories has further instructions stored thereon that, when executed by at least one of the one or more processors, cause at least one of the one or more processors to:
receive a first external event from the first entity computer system;
receive a second external event from the second entity computer system;
determine whether data corresponding to the first external event is consistent with data corresponding to the second external event; and
transmit one or more alerts based at least in part on a determination that the data corresponding to the first external event is inconsistent with the data corresponding to the second external event.

36. The integration platform of claim 20, wherein the instructions that, when executed by at least one of the one or more processors, cause at least one of the one or more processors to transform, by a second entity adapter of the integration platform, the event into a second entity event that is interpretable by the second entity computer system further cause at least one of the one or more processors to:
determine an event type of the event;
identify the second entity adapter in a plurality of second entity adapters based at least in part on the determined event type, the identified second entity adapter being configured to transform events of the event type into corresponding second entity events of the same event type; and
transform the event into the second entity event with the identified second entity adapter.

37. The integration platform of claim 20, wherein the frontend interface comprises one of a mobile application or a website.

38. The integration platform of claim 20, wherein frontend interface comprises an interface associated with the first entity.

39. At least one non-transitory computer-readable medium storing computer-readable instructions for bidirectional communication with heterogenous networked systems via an integrated frontend interface that, when executed by one or more computing devices of an integration platform, cause at least one of the one or more computing devices to:
transmit a frontend interface for display to a user, the frontend interface comprising a first interface corresponding to a first entity computer system on a computer network, wherein the integration platform is configured to expose one or more first functionalities mapped to the first entity computer system to the user via the first interface;
embed a second interface within the frontend interface, the second interface corresponding to a second entity computer system on the computer network, wherein the integration platform is configured to expose one or more second functionalities mapped to the second entity computer system to the user via the second interface, wherein the second interface is distinct from the first interface, and wherein the first entity computer system and the second entity computer system comprise distinct entities on the computer network;
detect an event in the second interface of the frontend interface;
determine that the event corresponds to the second entity computer system based at least in part on detecting the event in the second interface of the frontend interface;
transform the event into a second entity event that is interpretable by the second entity computer system, wherein a second entity adapter is configured to transform events in the second interface into corresponding second entity events on the second entity computer system; and
transmit the second entity event to the second entity computer system over the computer network.

40. The at least one non-transitory computer-readable medium of claim 39, further storing computer-readable instructions that, when executed by at least one of the one or more computing devices, cause at least one of the one or more computing devices to:
receive an external event from an external computer system;
identify an external event adapter in a plurality of external event adapters based at least in part on the identity of external computer system;
transform the external event into one or more native events with the identified external event adapter, the one or more native events being configured to update a state of the integration platform; and
update the state of the integration platform based at least in part on the one or more native events.

41. The at least one non-transitory computer-readable medium of claim 40, wherein the external computer system comprises one of the first entity computer system or the second entity computer system.

42. The at least one non-transitory computer-readable medium of claim 40, wherein the external computer system comprises the second entity computer system and wherein the external event is received from the second entity computer system in response to the second entity event transmitted to the second entity computer system.

43. The at least one non-transitory computer-readable medium of claim 40, wherein the instructions that, when executed by at least one of the one or more computing devices, cause at least one of the one or more computing devices to update the state of the integration platform based at least in part on the one or more native events further cause at least one of the one or more computing devices to:
update one or more records corresponding to the user in one or more databases of the integration platform based at least in part on the one or more native events.

44. The at least one non-transitory computer-readable medium of claim 40, wherein the instructions that, when executed by at least one of the one or more computing devices, cause at least one of the one or more computing devices to update the state of the integration platform based at least in part on the one or more native events further cause at least one of the one or more computing devices to:
update the frontend interface based at least in part on the one or more native events.

45. The at least one non-transitory computer-readable medium of claim 44, wherein the external computer system comprises the second entity computer system and wherein the instructions that, when executed by at least one of the one or more computing devices, cause at least one of the one or more computing devices to update the frontend interface based at least in part on the one or more native events further cause at least one of the one or more computing devices to:
update the second interface of the frontend interface based at least in part on the one or more native events.

46. The at least one non-transitory computer-readable medium of claim 40, wherein the external event comprises a replacement event configured to replace the second entity computer system with a third entity computer system on the computer network and wherein the instructions that, when executed by at least one of the one or more computing devices, cause at least one of the one or more computing devices to update the state of the integration platform based at least in part on the one or more native events further cause at least one of the one or more computing devices to:
reconfigure the embedded second interface to correspond to the third entity computer system, such that the exposed one or more second functionalities within the second interface are mapped to the third entity computer system rather than the second entity computer system.

47. The at least one non-transitory computer-readable medium of claim 46, wherein the instructions that, when executed by at least one of the one or more computing devices, cause at least one of the one or more computing devices to update the state of the integration platform based at least in part on the one or more native events further cause at least one of the one or more computing devices to:
retrieve user data corresponding to the user from the third entity computer system via a third entity external event adapter in the plurality of external event adapters; and
store user data in one or more databases of the integration platform.

48. The at least one non-transitory computer-readable medium of claim 46, further storing computer-readable instructions that, when executed by at least one of the one or more computing devices, cause at least one of the one or more computing devices to:
retrieve user settings data from one or more databases of the integration platform, the user settings data corresponding to the user and second entity computer system; and
transmit one or more instructions to the third entity computer system based at least in part on the user settings data.

49. The at least one non-transitory computer-readable medium of claim 39, further storing computer-readable instructions that, when executed by at least one of the one or more computing devices, cause at least one of the one or more computing devices to:
retrieve a first set of user data corresponding to the user from the first entity computer system via a first entity external event adapter in the plurality of external event adapters;
retrieve a second set of data corresponding to the user from the second entity computer system via a second entity external event adapter in the plurality of external event adapters; and
store the first set of data and the second set of data in one or more databases of the integration platform.

50. The at least one non-transitory computer-readable medium of claim 49, further storing computer-readable instructions that, when executed by at least one of the one or more computing devices, cause at least one of the one or more computing devices to:
partition the first set of data and the second set of data into a first partition and a second partition within the one or more databases of the integration platform; and
execute a role-based access control scheme, the role-based access control scheme being configured to control access to the first partition and the second partition based at least in part on an identity of a requesting entity.

51. The at least one non-transitory computer-readable medium of claim 50, wherein:
at least a portion of the first partition is accessible to the first entity computer system but the second partition is not accessible to first entity computer system;
at least a portion of the second partition is accessible to the second entity computer system but the first partition is not accessible to first entity computer system; and
at least a portion of the first partition and the second partition are accessible to the user.

52. The at least one non-transitory computer-readable medium of claim 39, further storing computer-readable instructions that, when executed by at least one of the one or more computing devices, cause at least one of the one or more computing devices to:
detect a second event in the first interface of the frontend interface;
determine that the second event corresponds to the first entity computer system based at least in part on detecting the second event in the first interface of the frontend interface;
transform the second event into a first entity event that is interpretable by the first entity computer system, wherein a first entity adapter is configured to transform events in the first interface into corresponding first entity events on the first entity computer; and
transmit the first entity event to the first entity computer system over the computer network.

53. The at least one non-transitory computer-readable medium of claim 39, wherein at least one of the one or more memories has further instructions stored thereon that, when executed by at least one of the one or more computing devices, cause at least one of the one or more computing devices to:
store user data in one or more databases of the integration platform;
receive an external event from an external computer system;
determine whether data corresponding to the external event is consistent with the user data in the one or more databases; and
transmit one or more alerts based at least in part on a determination that the data corresponding to the external event is inconsistent with the user data in the one or more databases.

54. The at least one non-transitory computer-readable medium of claim 39, further storing computer-readable instructions that, when executed by at least one of the one or more computing devices, cause at least one of the one or more computing devices to:
receive a first external event from the first entity computer system;
receive a second external event from the second entity computer system;
determine whether data corresponding to the first external event is consistent with data corresponding to the second external event; and
transmit one or more alerts based at least in part on a determination that the data corresponding to the first external event is inconsistent with the data corresponding to the second external event.

55. The at least one non-transitory computer-readable medium of claim 39, wherein the instructions that, when executed by at least one of the one or more computing devices, cause at least one of the one or more computing devices to transform, by a second entity adapter of the integration platform, the event into a second entity event that is interpretable by the second entity computer system further cause at least one of the one or more computing devices to:
determine an event type of the event;
identify the second entity adapter in a plurality of second entity adapters based at least in part on the determined event type, the identified second entity adapter being configured to transform events of the event type into corresponding second entity events of the same event type; and
transform the event into the second entity event with the identified second entity adapter.

56. The at least one non-transitory computer-readable medium of claim 39, wherein the frontend interface comprises one of a mobile application or a website.

57. The at least one non-transitory computer-readable medium of claim 39, wherein frontend interface comprises an interface associated with the first entity.
